(19) United States
(12) Patent Application Publication
(10) Pub. No.: US 2017/0039802 A1
(43) Pub. Date: Feb. 9, 2017

(54) Electronic Gaming Machine And Gaming Method

(71) Applicant: Ainsworth Game Technology Limited, Newington (AU)

(72) Inventors: Sujay Prabhu, Newington (AU); Peter Scott Clarebrough, Sydney (AU)

(21) Appl. No.: 14/855,672

(22) Filed: Sep. 16, 2015

(30) Foreign Application Priority Data
Aug. 7, 2015 (AU) 2015210436

(51) Int. Cl. G07F 17/32; G07F 17/34; A63F 9/24

(52) U.S. Cl. CPC G07F 17/3211; A63F 9/24; G07F 17/34; G07F 17/3288; A63F 2009/2457

(57) ABSTRACT

The invention provides an electronic gaming machine comprising a display for displaying a game comprising game symbols arranged into an array of predetermined game positions. An electronic game controller designates at least one of the predetermined game positions as a special game position in the array such that a special symbol appearing in the special game position in a play of the game causes the electronic game controller to award a game enhancing element to the player. The special game position is visually indicated on the array to the player during the play by a graphical element associated with the special game position. A gaming method is also provided.

### BACKGROUND

The present invention relates to an electronic gaming machine and in a particular an electronic gaming machine using a base game and a feature game. The invention has been developed primarily for use as an electronic gaming machine and will be described hereinafter by reference to this application.

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Conventional gaming machines typically involve awarding prizes to a player according to predetermined combinations of game symbols that appear on an array of game squares displayed on a screen, typically organized into three rows and five columns (commonly called a 5×3 array). Other arrays, such as a 3×3 or 4×3, may be used. Each gaming machine randomly selects the game symbols that appear on the array, each column of the array being a “reel”.

In an electronic gaming machine, the mechanical reels are replaced with video images of the reels, which are displayed on a video display screen. The electronic gaming machine has an internal electronic game controller, typically a computer, that controls the display of images on the video display screen so that the reels are visibly spun on the screen to simulate a physical reel of a traditional gaming machine. Electronic gaming machines are also more versatile in presenting game information, varying the probabilities for a player to win a prize and varying the type of game that is played.

Bonus or “feature” games may also be provided by an electronic gaming machine in addition to a base or main game. Typically feature games use the same set of reels as the main game and are limited to a set of free games operated under a single set of rules. This means that the feature game is restricted by the same set of rules, and so there is no variation in the play of the feature game.

Also, electronic gaming machines can offer one or more bonus prizes to the player during play of the game. The most common type of bonus prize that is awarded by the electronic gaming machine is a jackpot prize, the main example of which is a progressive jackpot prize.

This standard structure to game play and bonus prizes limits the variation in the play of the electronic gaming machine. Consequently, it is difficult to retain player interest because there is no apparent incentive for the player to continue playing the same electronic gaming machine once the player becomes familiar with the feature game, the main game and any bonus prizes. Also, it is difficult to retain player interest since there is little differentiation between gaming machines in terms of the main and feature games that are played.

It is an object of the present invention to overcome or substantially ameliorate one or more of the disadvantages of prior art, or at least to provide a useful alternative.

### SUMMARY

According to a first aspect of the invention, there is provided an electronic gaming machine comprising:

a display for displaying a game, wherein said game comprises game symbols arranged into an array of predetermined game positions and where predetermined winning combinations of randomly selected game symbols in said game award prizes to a player; and

an electronic game controller for controlling the display of said game symbols on said display;

wherein said electronic game controller designates at least one of said predetermined game positions as a special game position in said array, said game symbols being displayable in said special game position;

wherein two or more game positions are associated with said special game position; and

wherein a special symbol appearing in said special game position in a play of said game causes said electronic game controller to award a prize for each associated game position, said prizes being based on the game symbols displayed in said associated game positions.

Preferably, a first game symbol is associated with a first value that is higher than a second value associated with a second game symbol and the prize awarded for said first game symbol displayed in one of said associated game positions is higher in value than the prize awarded for said second game symbol displayed in one of said associated game positions.

Preferably, said game symbols have different values and each said prize is based on the value of the game symbol displayed in each said associated game position. More preferably, said game symbols have different values and said prize increases in value as the value of the game symbol displayed in each said associated game position increases.

Preferably, each said prize is proportional to the value of the game symbol displayed in each said associated game position

Preferably, said prize comprises a monetary prize. More preferably, said prize comprises an amount of credits.

Preferably, each said prize is displayed in each said associated game position. More preferably, each said prize is superimposed over the game symbol displayed in each associated game position.

Preferably, said associated game positions comprise the game positions adjacent said special game position. Preferably, said associated game positions comprise the game positions surrounding said special game position.

Preferably, said array comprises rows and columns of predetermined game positions and said associated game positions comprise the predetermined game positions in the same column as said special game position. More preferably, said associated game positions comprise the predetermined game positions in at least one column adjacent to the column containing said special game position. Alternatively, said associated game positions comprise the predetermined game positions in the adjacent columns on either side of the column containing said special game position.

Preferably, said array comprises rows and columns of predetermined game positions and said associated game positions comprise the predetermined game positions in at least one column adjacent to the column containing said special game position.

Preferably, said array comprises rows and columns of predetermined game positions and said associated game positions comprise the predetermined game positions in the same row as said special game position. More preferably, said associated game positions comprise the predetermined game positions in at least one row adjacent to the row containing said special game position.

Preferably, there is a plurality of said special game positions on said array, each special game position having respective associated game positions.

Preferably, there are two special game positions on said array, each special game position having respective associated game positions.

Preferably, the appearance of said special symbol in a game position adjacent to said special game position causes said special symbol to move into said special game position. More preferably, said special symbol swaps places with the game symbol in said special game position. In one embodiment, said array comprises an unequal number of rows and/or columns to create at least one additional game position adjacent to said special game position. In some embodiments, said array comprises at least one column comprising said special game position and said at least one additional symbol position. In one particularly preferred embodiment, said array comprises two columns, each having at least two special game positions and two additional game positions adjacent to said at least two special game positions.

Preferably, said special symbol comprises a jackpot symbol and the appearance of said jackpot symbol in said special game position causes the award of a jackpot prize. More preferably, there is a plurality of special game positions and the number of said jackpot symbols in said special game positions increases the value of said jackpot prize. Preferably, the frequency of said jackpot symbol appearing in said array depends on the amount bet by said player to play said game. More preferably, said frequency of said jackpot symbol appearing in said array increases as said amount bet increases. In one embodiment, said amount bet comprises the total amount bet for a play of said game.

Preferably, the frequency of said special symbol appearing in said array depends on the amount bet by said player to play said game. More preferably, said frequency of said special symbol appearing in said array increases as said amount bet increases. In one embodiment, said amount bet comprises the total amount bet for a play of said game.

Preferably, said special game position is visually indicated on said array during each play of said game by a graphical element associated with said special game position.

Preferably, said graphical element comprises a graphically enhanced element. More preferably, said graphical element comprises a highlighted boundary of said special game position. Alternatively, said graphical element comprises an animation associated with said special game position. In one embodiment, said animation comprises an animation of said special game position or said boundary. In other embodiments, said graphical element comprises an animation of said special symbol appearing in said special game position.

Preferably, said graphical element is displayed on said display at all times on said electronic gaming machine. Alternatively, said graphical element is displayed from the start of a play of said game until the end of said play. That is, the graphical element is only displayed once the special game position is designated at the start of said play prior to the reels being spun, or at least before the reels have displayed any game symbols for the result of the play of the game and remains in position until the end of said play when all reels have completed spinning and the associated results of the play of the game are known to the player.

Preferably, said graphical element comprises an area within said array associated with said special game position. More preferably said associated area changes in response to said special symbol appearing in said special game position.

Preferably, said electronic game controller awards a game enhancing element in response to the appearance of said special symbol in said special game position. Preferably, said one or more game enhancing elements modify the result of a play of said game. More preferably, said game enhancing element comprises at least one or more of a predetermined number of free games, a win multiplier, wild multipliers, bonus wilds, symbols that cause the award of additional free games, trigger symbols to retrigger said at least two second arrays, held columns, random wild symbols, stacked symbols, bonus symbols, new game symbols, reveal symbols, progressives, bonus credits, jackpot symbols, and one or more symbol replacements.

Preferably, said electronic game controller designates a different predetermined game position as said special game position between two plays of said game. More preferably, said two plays are successive plays of said game. In an alternative form, said two plays are the first and last plays of a predetermined number of plays of said game. More preferably, said electronic game controller designates a different predetermined game position as said special game position between a play of said base game and a play of said feature game.

Preferably, there is a plurality of special game positions on said array. More preferably, said array comprises rows and columns of predetermined game positions and at least one of said columns comprises only said special game positions. In one embodiment, said special game positions are respectively associated with different game enhancing elements.

Preferably, the game comprises a base game. Preferably, said game comprises a feature game. More preferably, there is both a base game and a feature game. In some embodiments, said special game position is available for play only in said base game, only in said feature game or in both said base game and said feature game.

Preferably, said electronic gaming machine comprises a base game and a feature game, wherein said base game and said feature game each comprises an array of rows and columns of said predetermined game positions, and said base game array is different in size and/or dimensions to said feature game array. More preferably, said feature game array is greater in size than said base game array. In one embodiment, said base array comprises three rows and five columns and said feature game array comprises either more than three rows or more than five columns. In a further embodiment, said feature game array is an extended base game array.

Preferably, a feature game trigger event occurs in said base game to trigger said feature game. In one embodiment, said feature game trigger event comprises a random event determined by said electronic game controller at the start of play of said feature game. In another embodiment, the feature game trigger event comprises the appearance of at least one trigger symbol in said base game array. In another alternative, the feature game trigger event comprises an in-game event during play of the base game.

Preferably, said array (including the base game array and/or the feature game array) takes any one of a circular, triangular, oval, semi-circular, hexagonal, pentagonal, octagonal, non-rectangular or polygonal shape.

Preferably, in response to a feature game trigger event in said base game, said electronic game controller causes said display to display game symbols for playing said feature game. Alternatively, said electronic game controller causes the display of said feature game and said base game during play of said base game, said feature game being inactive until triggered. In this embodiment, the change in said feature game from being inactive to active may be indicated on the display. This indication may be visual, aural or a combination of both.

Preferably, said array comprises one or more rows and/or columns of said symbol positions. In one embodiment, said array comprises a plurality of reels. In another embodiment, said player selectively starts and/or stops play of said reels in said game array and/or said reels in said feature game.

Preferably, said electronic gaming machine comprises a housing having said display and containing said electronic game controller.

Preferably, said electronic gaming machine comprises an input device. It is also preferred that said input device comprises one or more buttons on said housing, said buttons being in electronic communication with said electronic game controller to transmit player commands to said electronic game controller. More preferably, said buttons are arranged on a console of said housing. Alternatively or additionally, said input device comprises a touch sensitive surface on said display for receiving player commands, said touch sensitive surface being in electronic communication with said electronic game controller to transmit player commands to said electronic game controller.

Preferably, said electronic gaming machine comprises a value transfer mechanism for paying said prizes to said player using value in an amount equal to an awarded prize. Alternatively or additionally, said value transfer mechanism receives value from said player to make said bet and initiate play of a game on said electronic gaming machine. The game comprises the first game and/or the second game. More preferably, said value transfer mechanism is in electronic communication with said electronic game controller. It is also preferred that said value transfer mechanism is provided on said housing. In one embodiment, said value transfer mechanism comprises one or more vending slots for paying and/or receiving value. In other embodiments, said value transfer mechanism comprises a value input/value output device. In further embodiments, said value transfer mechanism comprises a coin slot or acceptor, a paper currency acceptor, a ticket reader and/or printer or a card reader and/or writer.

Throughout the specification and unless explicitly stated otherwise, the term “value” means money denominations, credits, gaming tokens, coins, paper, currency, tickets, vouchers (both physical and electronic), credit cards, debit cards, smart cards, memory devices capable of storing value and any other object representative of value.

Preferably, the electronic gaming machine comprises a mobile electronic gaming device. More preferably, said mobile electronic gaming device comprises a handheld electronic device. Alternatively, said electronic gaming machine comprises a computer. More preferably, said computer is connected to a communication network.

A second aspect of the present invention provides an electronic gaming machine comprising:

a display for displaying game symbols for playing a game, said game comprising game symbols arranged into an array of predetermined game positions and where predetermined winning combinations of randomly selected game symbols in said game award prizes to a player;

an electronic game controller in electronic communication with said display for controlling the appearance of said game symbols on the display; and

a value transfer mechanism for receiving value from a player to make a bet and initiate play of said game on said display, said value transfer mechanism being in electronic communication with said electronic game controller;

wherein said electronic game controller in response to said player making a bet via said value transfer mechanism commences play of said game by randomly selecting game symbols and transmitting a signal to said display to display said randomly selected game symbols;

wherein said electronic game controller designates at least one of said predetermined game positions as a special game position in said array, said game symbols being displayable in said special game position;

wherein two or more game positions are associated with said special game position; and

wherein a special symbol appearing in said special game position in a play of said game causes said electronic game controller to award a prize for each associated game position, said prize being based on the game symbols displayed in said associated game position.

This second aspect of the invention preferably has the preferred features of the first aspect of the invention stated above, where applicable.

According to a third aspect of the invention, there is provided a gaming method for an electronic gaming machine comprising a display and an electronic game controller, comprising:

controllably displaying game symbols on said display to play a game, wherein predetermined winning combinations of randomly selected game symbols in said game award prizes to a player;

arranging said game symbols into an array of predetermined game positions;

designating at least one of said predetermined game positions as a special game position in said array;

associating two or more game positions with said special game position; and

in response to the appearance of a special symbol in said special game position in a play of said game, awarding a prize for each associated game position, said prizes being based on the game symbols displayed in said associated game positions.

Preferably, said method comprises said electronic game controller associating a first game symbol with a value higher than a second game symbol and awarding a prize higher in value for said first game symbol displayed in one of said associated game positions than the prize awarded for said second game symbol displayed in one of said associated game positions.

Preferably, said method comprises said electronic game controller allocating different values for said game symbols and determining said prize based on the value of the game symbol displayed in each said associated game position. More preferably, said electronic game controller increasing the value of said prize as the value of the game symbol displayed in each said associated game position increases.

Preferably, said method comprises awarding each said prize as a proportion of the value of the game symbol displayed in each said associated game position.

Preferably, said electronic game controller awards a monetary prize. More preferably, said electronic game controller an amount of credits as said prize.

Preferably, said method comprises displaying each said prize in each said associated game position. More preferably, said method comprises superimposing each said prize over each game symbol displayed in each associated game position.

Preferably, said method comprises associating the game positions adjacent said special game position. Preferably, said method comprises associating the game positions surrounding said special game position.

Preferably, said method comprises associating arranging said array into rows and columns of predetermined game positions and associating the predetermined game positions in the same column as said special game position. More preferably, said method comprises associating the predetermined game positions in at least one column adjacent to the column containing said special game position. Alternatively, said method comprises associating the predetermined game positions in the adjacent columns on either side of the column containing said special game position.

Preferably, said method comprises associating arranging said array into rows and columns of predetermined game positions and associating the predetermined game positions in at least one column adjacent to the column containing said special game position.

Preferably, said method comprises associating arranging said array into rows and columns of predetermined game positions and associating the predetermined game positions in the same row as said special game position. More preferably, said method comprises associating arranging said array into rows and columns of predetermined game positions and associating the predetermined game positions in at least one row adjacent to the row containing said special game position.

Preferably, said method comprises providing a plurality of said special game positions on said array and associating respective game positions with each special game position.

Preferably, said method comprises providing two special game positions on said array and associating respective game positions with each special game position.

Preferably, said method comprises visually indicating said special game position on said array to said player during each play of said game by a graphical element associated with said special game position.

Preferably, the method further comprises associating a graphical element with each said special game position to visually indicate each said special game position to said player.

Preferably, said method further comprises graphically enhancing the visual appearance of said special game position.

Preferably, said method further comprises highlighting a boundary of said special game position.

Preferably, said method further comprises associating an animation with said special game position. More preferably, said method further comprises animating said special game position or said boundary.

Preferably, said method further comprises displaying said graphical element on said display at all times on said electronic gaming machine. Alternatively, said method further comprises displaying said graphical element from the start of a play of said game until the end of said play.

Preferably, said associating step further comprises changing an area within said array associated with said special game position in response to said special symbol appearing in said special game position.

Preferably, wherein said designating step comprises designating said special game position only in a base game, only in a feature game or both in said base game and said feature game. More preferably, said base game and said feature game each comprises an array of rows and columns of said predetermined game positions, and said method further comprises displaying said base game array in a different size and/or dimensions to said feature game array. In one embodiment, said feature game array is greater in size than said base game array. In another embodiment, said base array comprises three rows and five columns and said feature game array comprises either more than three rows or more than five columns.

Preferably, said designating step comprises designating a different predetermined game position as said special game position between two plays of said game.

Preferably, said method comprises awarding a game enhancing element in response to the appearance of a special symbol in said special game position in said play of said game.

Preferably, said method comprises displaying said array in a rectangular, circular, triangular, oval, semi-circular or other non-rectangular shape.

Preferably, said method comprises providing said game as a base game. Preferably, said method comprises providing said game as a feature game.

Preferably, said method comprises providing a base game and a feature game, wherein, in response to a feature game trigger event in said base game, said electronic game controller causes said display to display game symbols for playing said feature game. Alternatively, said method comprises said electronic game controller causing the display of said feature game and said base game during play of said base game, said feature game being inactive until triggered. In this embodiment, said method comprises indicating on the display the change in said feature game from being inactive to active. Preferably, the indicating step may be visual, aural or a combination of both.

Preferably, said method comprises arranging said array into one or more rows and/or columns of said symbol positions. In one embodiment, said method comprises arranging said array into a plurality of reels. Preferably, said method comprises enabling said player to selectively start and/or stop play of said reels in said array.

The method of the third aspect of the invention preferably has the preferred features of the first aspect of the invention where applicable.

A fourth aspect of the present invention provides a gaming method for an electronic gaming machine comprising a display for displaying a first game, wherein said game comprises displaying randomly selected game symbols, wherein the display of predetermined winning combinations of said game symbols results in the award of prizes to a player; an electronic game controller for controlling the display of said game symbols for playing said game on said display; and a value transfer mechanism for receiving value from a player to make a bet and initiate play of said game on said display, said value transfer mechanism being in electronic communication with said electronic game controller, the method comprising:

said electronic game controller arranging said game symbols into an array of predetermined game positions;

said electronic game controller designating at least one of said predetermined game positions as a special game position in said array, wherein said game symbols are displayable in said special game position;

said electronic game controller associating two or more game positions with said special game position; and

in response to the appearance of a special symbol appearing in said special game position in a play of said game, said electronic game controller awarding a prize for each associated game position, said prizes being based on the game symbols displayed in said associated game positions.

The method of the fourth aspect of the invention preferably has the preferred features of the third aspect of the invention stated above, where applicable.

According to a fifth aspect of the invention, there is provided a computer system comprising a central processing unit configured for communication with an electronic gaming machine, wherein said computer system is configured to perform the method of the third or fourth aspects of the invention.

According to a sixth aspect of the invention, there is provided a computer program configured to perform the method of the third or fourth aspects of the invention.

According to a seventh aspect of the invention, there is provided a non-transitory carrier medium carrying computer executable code that, when executed on a central processing unit configured for communication with an electronic gaming machine, causes the central processing unit to perform the method of the third or fourth aspects of the invention.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### BRIEF DESCRIPTION OF THE DRAWINGS

Preferred embodiments of the invention will now be described, by way of example only, with reference to the accompanying drawings in which:

FIG. 1 is a perspective view of an electronic gaming machine according to an embodiment of the invention;

FIG. 2 is a schematic drawing of an electronic game controller for the electronic gaming machine of FIG. 1;

FIG. 3 is a simulated screen shot illustrating a base game played on the electronic gaming machine of FIG. 1;

FIG. 4 is a simulated screen shot illustrating a feature game played on the electronic gaming machine of FIG. 1;

FIGS. 5A to 16B are simulated screen shots of the base game of FIG. 3 illustrating one embodiment of the invention;

FIG. 17 is a simulated screen shot of a game illustrating another embodiment of the invention;

FIGS. 18A to 18D are schematic drawings illustrating alternative jackpot awarding mechanisms for the embodiments of FIGS. 3 to 17;

FIGS. 19A and 19B are schematic drawings illustrating a further embodiment of the invention;

FIGS. 20A and 20B are schematic drawings illustrating another embodiment of the invention;

FIG. 21 is a perspective view of an electronic gaming machine according to another embodiment of the invention;

FIG. 22 is a schematic drawing of a control panel for the electronic gaming machine of FIG. 21; and

FIG. 23 is a block diagram of the electronic components of the electronic gaming machine of FIG. 21.

### DETAILED DESCRIPTION OF VARIOUS EMBODIMENTS

The present invention will now be described with reference to the following examples which should be considered in all respects as illustrative and non-restrictive. In the Figures, corresponding features within the same embodiment or common to different embodiments have been given the same reference numerals.

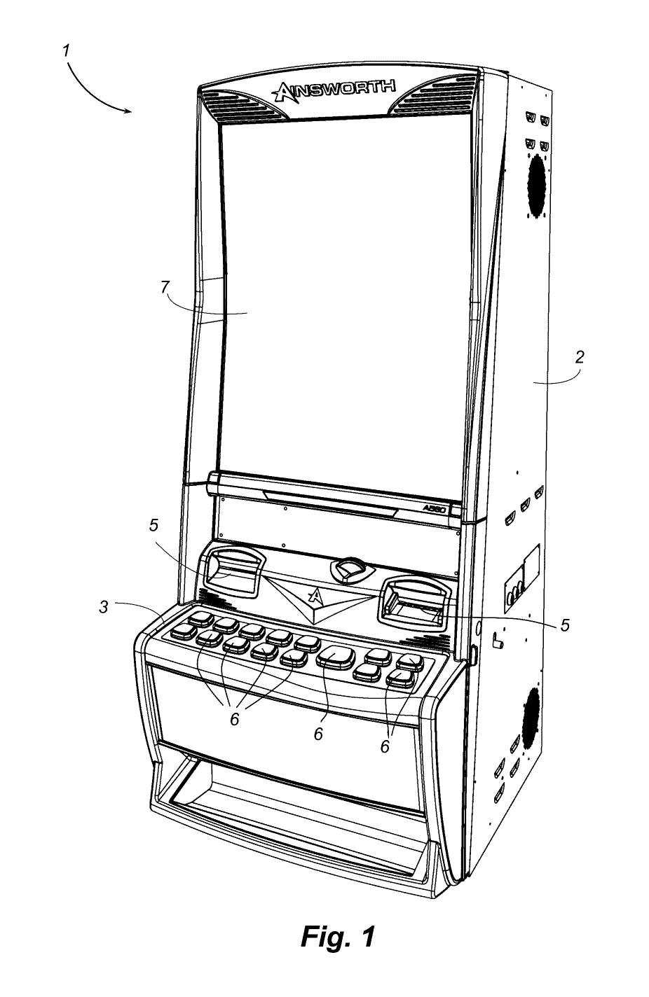

Referring to FIG. 1, an electronic gaming machine 1 according to a first embodiment of the invention includes a cabinet 2, a console 3 and an internal electronic game controller 4. The console 3 has various input devices including vending slots 5 for receiving monetary bets and a plurality of buttons 6 for actuation by a player. It will be appreciated that in other embodiments the vending slots 5 may be replaced with other types of value input/value output devices, such as a coin acceptor, a paper currency acceptor, a ticket reader and/or printer or a card reader and/or writer.

The vending slots 5 can be configured to receive value, such as cash in the form of banknotes and coins, or credits representing a monetary amount from a memory device, such as but not limited to a memory card, smart card, a radio frequency identification (RFID) device, USB key, magnetic card or other electronic storage device. Typically, the memory device is a credit card, debit card or other card that enables the transfer of monetary credit to the electronic gaming machine 1. Other forms of value include gaming tokens, paper, tickets, vouchers, and any other object representative of value.

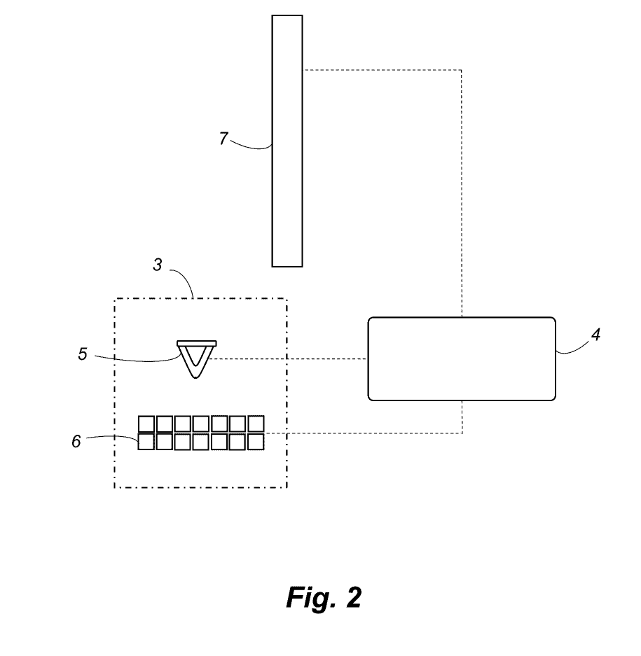

The electronic game controller 4 is generally in the form of a central processing unit, such as a computer, and is in electronic communication with a display in the form of a video display screen 7, as well as various input devices on the console 3, as best shown in FIG. 2. Typically, the electronic game controller 4 also comprises a random access memory (RAM) associated with the central processing unit, the RAM being used to store program instructions and transient data related to the operation of the electronic game controller and hence the electronic gaming machine 1. The RAM contains a body of program instructions for implementing a game on the electronic gaming machine 1, as discussed in more detail below. The central processing unit or processor may also be operatively associated with a further storage device, such as a hard disk drive, which is used for long-term storage of program components and data relating to the electronic game controller 4 and/or the electronic gaming machine 1, including a database for game performance data, as well as information gathered from users. It is also appreciated that a person skilled in the art would readily understand the location and use of the electronic game controller 4 in the electronic gaming machine 1.

The electronic game controller 4 will transmit and receive signals to and from each of the input devices and the display 7, usually via wired connections but can include wireless modes of electronic communication, such as WLAN. In the case of the vending slots 5 (or with any other type of value transfer mechanism), there may be an intermediate credit verification device that examines and verifies the cash or credits received by the vending slots. Once the value (such as cash or credits) have been verified by the credit verification device, a signal is sent to the electronic game controller 4, which then determines whether the minimum bet level has been reached. If so, the electronic game controller 4 will permits play of the game on the electronic gaming machine 1. If not, the electronic game controller 4 will send a signal to the display 7 to show a message requesting further value to be added to the electronic gaming machine 1.

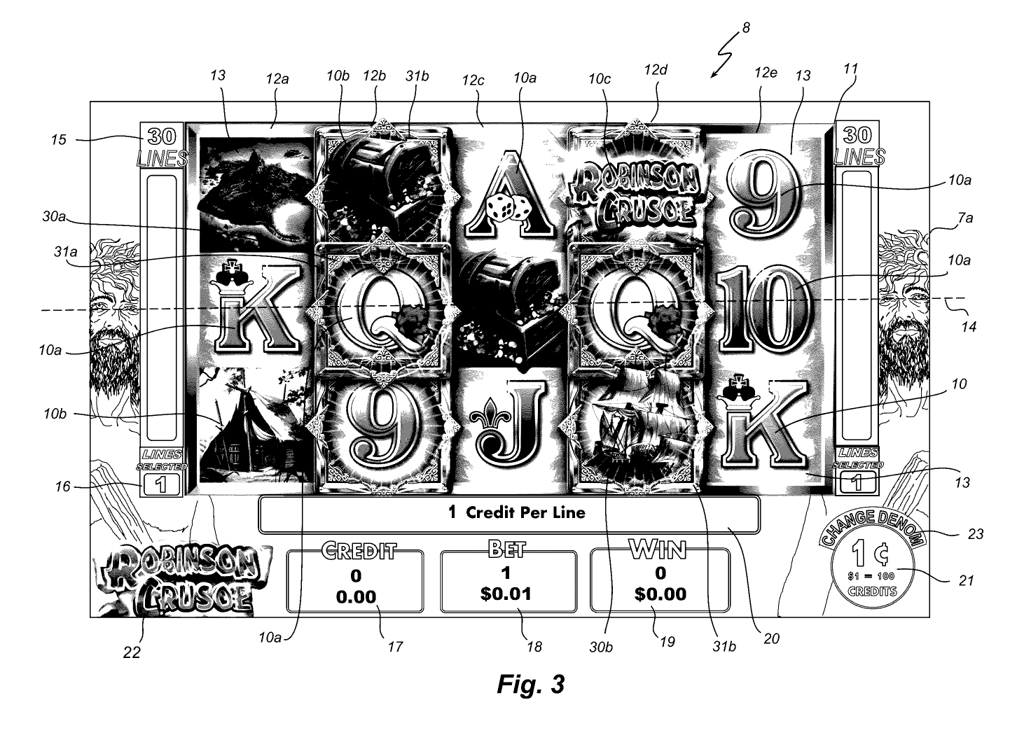

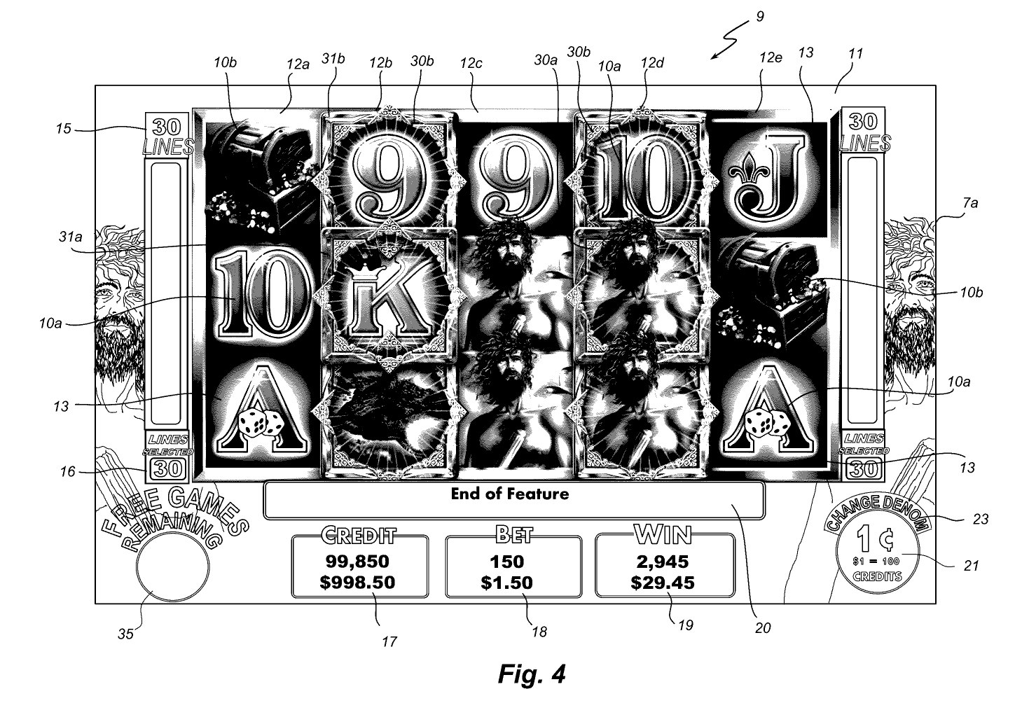

The electronic game controller 4 is programmed to provide a game in the form of a base game 8 (as best shown in FIG. 3) and a feature game 9 (as best shown in FIG. 4) on a lower display area 7a of the display 7 of the electronic gaming machine 1 for play by a player. The base game 8 has game symbols 10 arranged into an array 11 in the form of five columns or “reels” 12a, 12b, 12c, 12d and 12e. The reels 12a, 12b, 12c, 12d and 12e give the visual appearance of rotating, typically by having the game symbols 10 move in a downward linear path along the length of each reel 12a, 12b, 12c, 12d and 12e. The array 11 is arranged with five reels 12a, 12b, 12c, 12d and 12e and three rows as per the industry standard, it will be appreciated by one skilled in the art that other types of arrays could be used, such as 3×3, 4×3, 5×5, 4×4, etc, including arrays having an irregular number of rows and/or columns. For example, the array 11 can have an unequal number of rows and/or columns, where some columns have less or more rows than other columns or where some rows have less or more columns than other rows. A more specific example would be an array having three columns with only two rows and two columns with three rows. The electronic game controller 4 will transmit signals to the display screen 7 to cause the base game 8 and feature game 9 to be played on the lower display area 7a, including showing the game symbols 10, array 11 and other visible elements of the games.

The array 11 of the base game 8 defines predetermined symbol positions 13, in which the game symbols 10 appear. In this embodiment, the symbol positions 13 are not defined by any visible boundary lines and simply provide an area for the game symbols 10 to appear. However, it will be appreciated that in other embodiments, the symbol positions 13 are visually marked by boundary lines to define “squares” or “cells”. In yet other embodiments, other markings can be used to define each respective area of the symbol positions 13 or game positions.

The array 11 is arranged so that a player can select one or more predetermined “pay lines” 14 defined around the array, which correspond to combinations of the symbol or game positions 13. The pay lines 14 correspond to the lines selected by the player and generally comprise at least one game position or symbol position 13 from each reel 12. The number of pay lines 14 that can be selected by the player depends on the amount of the monetary bet for playing a game on the array 11. In the base game 8, predetermined winning combinations of randomly selected game symbols 10 result in the award of prizes to the player.

The game symbols 10 can include a mixture of picture symbols (such as animal symbols or playing card symbols), word symbols, scatter symbols, substitute or wild card symbols and trigger symbols. Those skilled in the art will readily understand that a substitute symbol is able to act as any other game symbol, and hence is also known as a “wild card” symbol. Likewise, those skilled in the art will readily understand that a scatter symbol is a symbol that triggers a game event or confers an award without having to appear on a player-selected pay line 14. Similarly, a trigger symbol is a symbol that triggers a game event (like activating a feature game) or confers an award, where the trigger symbol may or may not have to appear in combination and may or may not have to appear on the same player-selected pay line 14. In this embodiment, the game symbols 10 include playing card symbols 10a, picture symbols 10b and a scatter symbol 10c in the form of a “Robinson Crusoe Logo” symbol, which will be referred hereinafter as the Logo symbol 10c. The Logo symbol 10c also acts as a trigger symbol to trigger the feature game 9. In this embodiment, there are several substitute or wild card symbols in the form of a “Man” symbol 10d, “Gold Globe” symbol 10e and “Cash Adventure” symbol 10f. The Man symbol 10d is limited to appearing on reels 12b to 12e, the Gold Globe symbol 10e only appears on reel 12c and the Cash Adventure symbol 10f only appears on reels 12b and 12d. There is also a trigger symbol in the form of a Jackpot symbol 10g for triggering the award of a jackpot. The electronic game controller 4 randomly determines the appearance of the game symbols 10 on the array 11.

The lower display area 7a also displays other standard game information including the number of pay lines 15, the number of pay lines selected 16, the amount of player credits 17, the amount of the current bet wagered by the player 18, the amount of wins by the player 19, a message area 20, a current denomination button 21 indicating the currently selected base bet denomination, the name of the game 22 “Robinson Crusoe”™ and a message strip 23 advising the player that the current denomination can be changed. Other standard information may also include a menu button (not shown) for bringing up a menu screen (not shown).

An upper display area 7b of the video screen 7 may display an animated title or feature screen for the game and/or information relating to the rules for the base game 8 and feature game 9 discussed below. This includes information outlining the key characteristics of the base game 8 and feature game 9. The upper display area 7b may also displays jackpot information relating to the base game 8 and/or feature game 9 that are awarded by the electronic gaming machine 1. This jackpot information in this embodiment comprises, in descending order of monetary value, a grand jackpot, major jackpot, minor jackpot and mini jackpot.

The array 11 also has designated special game positions 30a, 30b that are each visually indicated to the player during play of the base game 8 by respective graphical elements 31a, 31b. In this embodiment, there are six special game positions 30a, 30b in the base game 8 that occupy reels 12b and 12d (typically called reels 2 and 4). The graphical elements 31a, 31b are graphically enhanced to ensure that the player can distinguish the special game positions 30a, 30b from the other game positions 13 in the array 11 during game play. In this embodiment, the graphical elements 31a, 31b takes the form of a highlighted boundary that surrounds each special game position 30a, 30b.

The boundaries 31a, 31b have distinct colours that distinguish the special game positions 30a, 30b from each other, as we as the other game positions 13 in the array 11. Generally, the middle special game position 30a of each reel 12b, 12d has a red boundary 31a and the top and bottom special game positions 30b of each reel 12b, 12d have a blue boundary 31b. It is preferred that adjoining special game positions 30 alternate in colour to assist in distinguishing the special game positions from each other. Also, each boundary 31a, 31b is animated by having a flashing chaser light move along the boundary during game play to further highlight the special game positions 30 visually to the player. Thus, the player is able to discern the special game positions 30 conveniently and without difficulty during game play and thus is able to be look out for special symbols appearing in the special game positions 30.

The electronic game controller 4 associates one or more game positions with each special game position 30a, 30b. In this embodiment, the special game positions 30a, 30b are associated with the blue special game position 30b in the same column or reel. Thus, the top blue special game position 30b and the red special game position 30a in reel 12b is associated with the bottom blue special game position 30b of reel 12b. Likewise, the bottom blue special game position 30b and the red special game position 30a in reel 12b is associated with the top blue special game position 30b of the reel 12b. The same relationship occurs for the top and bottom blue special game positions 30b in reel 12d; i.e. they are each associated with the red special game position 30a of reel 12d and the bottom and top blue special game positions 30b, respectively.

Also in this embodiment, each of the game positions surrounding the special game position 30a is associated with the special game position. That is, the game positions in the reels adjacent to the reel containing the red special game position 30a and the blue special game positions 30b in the same reel as the red special game position 30a are associated with the red special game position 30a. For example, all the game positions 13 in reels 12c and 12e and the special game positions 30b in reel 12d are associated with the special game position 30a in reel 12d. Likewise, all the game positions 13 in reels 12a and 12c and the special game positions 30b in reel 12b are associated with the special game position 30a in reel 12b.

The player initially makes a bet using vending slots 5 initiate play of the electronic gaming machine 1 to build up credit to play the base game 8 on the electronic gaming machine. For example, the player can bet or wager monetary amounts equivalent to a particular amount of credits, depending on the bet denomination selected for the base game. Also, the player can make any additional side bets or ante-bets during play of the base game once the game has commenced to access additional features in the game, such as increasing the number of winning combinations in the game.

Typically, electronic gaming machines offer a number of preset bet options that the player can make, and these bet options can vary depending on the game or games offered on the electronic gaming machine. For example, a game on an electronic gaming machine may provide bet options of 1 credit, 2 credits, 5 credits and 10 credits per player-selected pay line 14. In another example, the player may bet 1 credit, 2 credits, 5 credits and 10 credits for a preset group or combination of pay lines 14, such as a group of 5 pay lines, 10 pay lines, 20 pay lines, etc. Usually, the bet option selected determines the number of pay lines 14 that become payable in the base game 8 and/or feature game 9. In this embodiment, the electronic gaming machine 1 provides bet options of 1 credit, 2 credits, 3 credits, 5 credits and 20 credits bet per player-selected pay line 14 and enables the player to select pay lines in groups of 1, 5, 10, 25 and 50 pay lines.

The electronic gaming machine also typically has a default bet denomination, which is usually the bet denomination that was previously used in the preceding play of the base game 8. For example, if a person had played the base game 8 with a bet denomination of 5¢, then this would be the default bet denomination for the player when he or she commences play of the game. Where the electronic gaming machine has not yet been played or has been started up, the default bet denomination is initially selected by the electronic game controller 4. The default bet denomination can be randomly selected or chosen according to a predetermined order. Typically, the electronic game controller 4 will select the bet denomination with the lowest value that is available for the base game 8, which would be the 1¢ bet denomination for this embodiment. The player may change the bet denomination at any time in the base game 8 by touching the denomination button before or after the reels 12 have spun. In this embodiment, touching the denomination button 21 will bring denomination images (including from 1¢, 2¢, 5¢ 10¢, 20¢, 50¢ and up to $1) that the player may select to quickly change the bet denomination between plays of the game 8. In other embodiments, the message strip 23 is also touch sensitive icon to enable the bet denomination to be changed.

Once the player has made a bet to commence play of the game 8, the electronic game controller 4 then transmits a signal to the display 7 to make reels 12 to appear to visibly rotate or “spin” in a linear path, typically in a downward vertical direction, and randomly display the game symbols 10 in each symbol position 13 and the special game positions 30a, 30b, as indicated by the boundaries 31a, 31b, for each play of the array 11 for the base game 8. After the reels 12 stop spinning, the electronic game controller 4 determines whether there are any predetermined winning combinations of the game symbols 10 appearing in any player-selected pay lines 14, such as a two of a kind, three of a kind, four of a kind or five of a kind for all the game symbols 10. Where playing card symbols are optionally used, other predetermined winning combinations include poker-based combinations of a “full house”, “straight” or “flush”. It will be appreciated that other winning combinations of game symbols 10 can also be provided. If so, the electronic gaming machine 1 enters a winning game state and awards a prize according to the displayed predetermined winning combination.

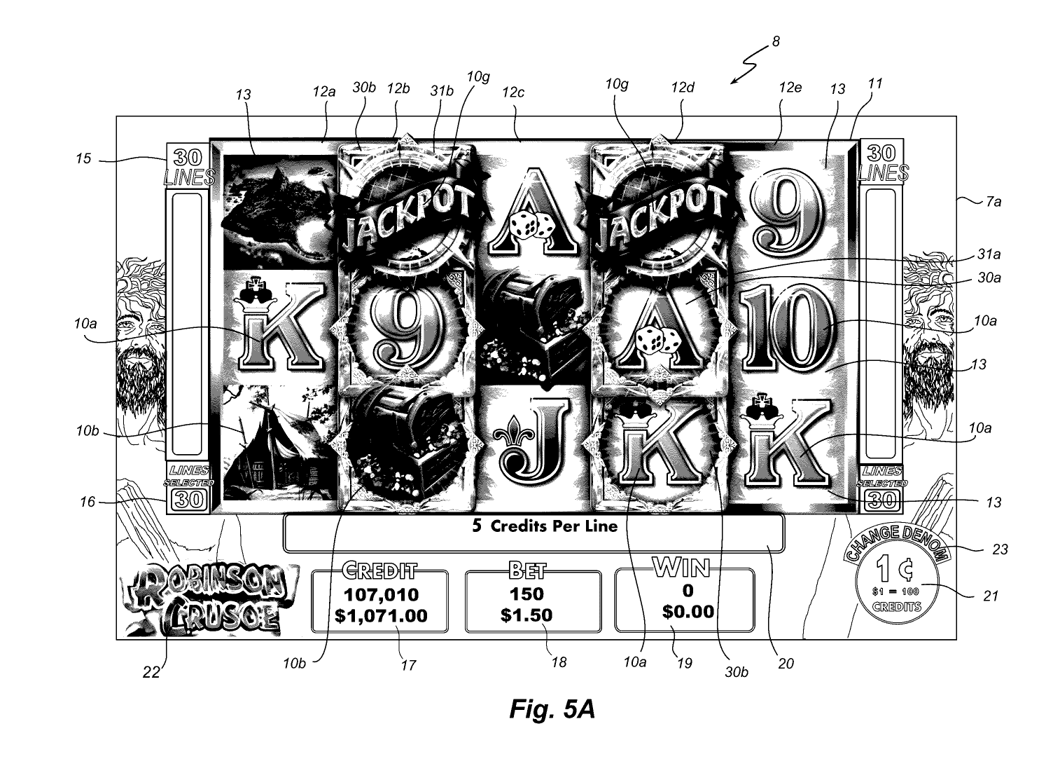

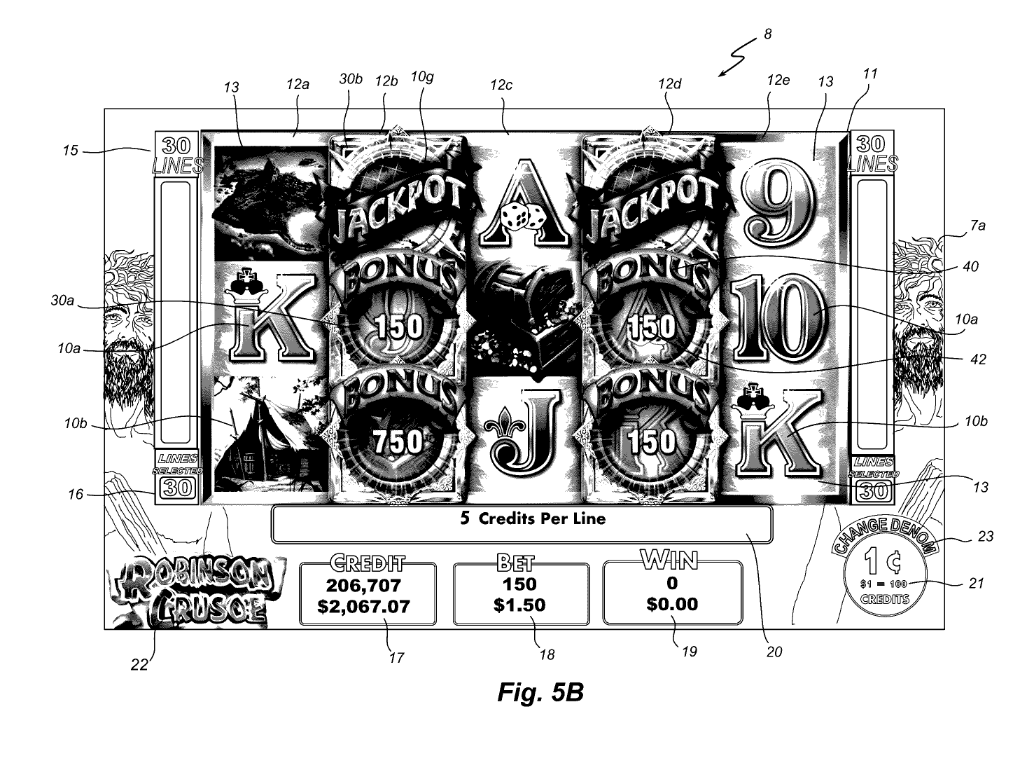

The electronic game controller 4 then determines whether a special symbol has appeared in one of the special game positions 30a, 30b. If so, this causes the electronic game controller 4 to award a prize for each game position associated with the special game position 30a, 30b. In this embodiment, there are two types of special symbols, being the Cash Adventure symbol 10f and the Jackpot symbol 10g. For example, if the Jackpot symbol 10g appears in one of the blue special game positions 30b (i.e. the top or bottom special game position 30b in either reel 12b or 12d), then a prize is awarded for each game symbol displayed in the special game positions 30a, 30b in the same reel (either reel 12b or 12d), as best shown in FIGS. 4 and 5. If the Jackpot symbol 10g appears in one of the red game positions 30a (i.e. the middle special game position 30 in either reel 12b or 12d), then a prize is awarded for each game symbol displayed in the game positions in adjacent reels (reels 12a and 12c for the red special game position 30a in reel 12b or reels 12c and 12e for the red special game position 30a in reel 12d) and the blue special game positions 30b in the same reel as the red special game position 30a. The same effect equally occurs where the Cash Adventure symbol 10f appears in one of the red or blue special game positions 30a, 30b in reels 12b and 12d. The difference between the Cash Adventure symbol 10f and the Jackpot symbol 10g is that the Jackpot symbol 10g also provides the player to win one of the available jackpots on the electronic gaming machine 1.

Also in this embodiment, the prize is a monetary prize in the form of credits, and the amount of the prize depends on the game symbol 10 displayed in the associated game position. Thus, where a game symbol 10 (such as an Ace symbol) has a value higher than another game symbol (such as a Queen symbol), then the amount of credits awarded for the first game symbol (Ace symbol) will be higher than the amount of credits awarded for the second game symbol (Queen symbol). This is best illustrated by way of reference to FIGS. 5A to 16B, which show various combinations of the Cash Adventure and Jackpot symbols 10f, 10g appearing in the special game positions 30a, 30b and the resultant prizes awarded.

In FIG. 5A, the Jackpot symbol 10g has appeared in both top blue special game positions 30b of the reels 12b and 12d. In response, the electronic game controller 4 causes the award of a prize for each of the game positions associated with the top blue special game positions 30b, being the bottom blue special game positions 30b and the red special game positions 30a, as best shown in FIG. 5B. The prize awarded varies depending on the game symbol 10 shown in the associated game positions. In this case, playing card symbols 10a have appeared in three of the associated game positions (as best shown in FIG. 5A), resulting in the award of 150 credits for each playing card symbol (as best shown in FIG. 5B). However, the picture symbol 10b (being a treasure chest) displayed in the bottom blue special game position 30b of the reel 12b has a higher value than the playing card symbol 10a and so a prize of greater value is awarded, being 750 credits. The awarded prizes are accompanied by a BONUS image 40 that forms a frame around the stated prize 42 and is superimposed over the game symbol 10, which remains partly visible, as best shown in FIG. 5B.

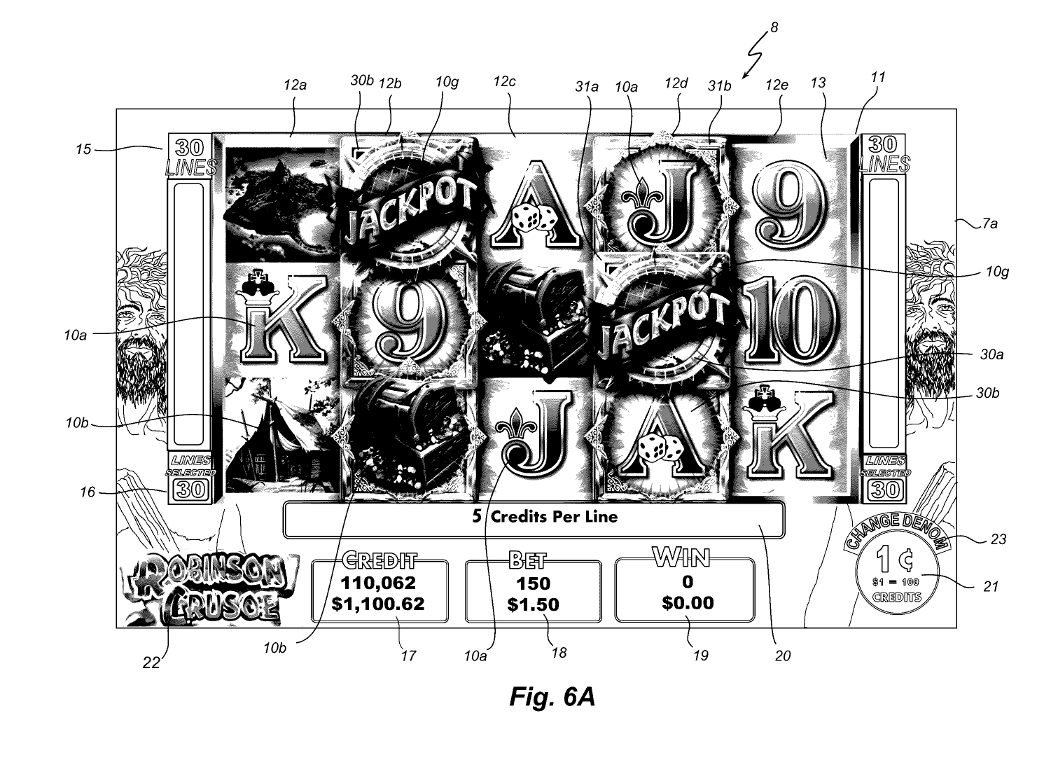

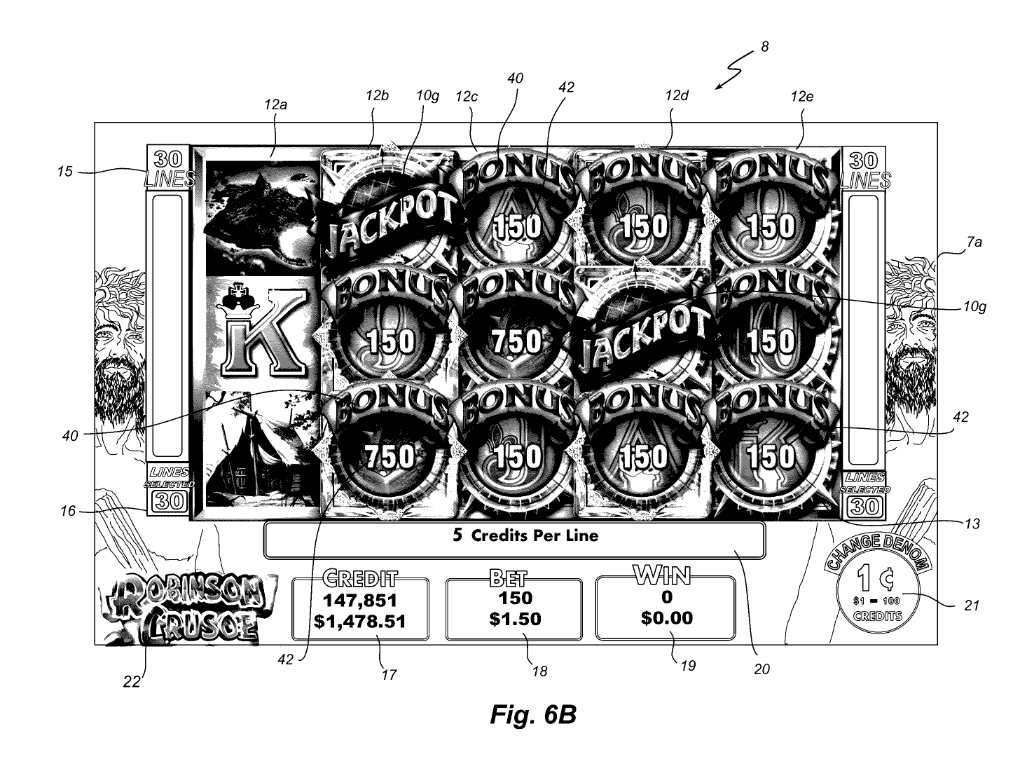

In FIG. 6A, the Jackpot symbol 10g has appeared in the top blue special game position 30b of the reel 12b and the red special game position 30a of the reel 12d. In response, the electronic game controller 4 causes the award of a prize for each of the game positions associated with the top blue special game position 30b, being the bottom blue special game position 30b and the red special game position 30a of reel 12b and the game positions associated with the red special game position 30a, being all the game positions 13 of reel 12c and 12e and the blue special game positions 30a of reel 12d, as best shown in FIG. 6B. As shown in FIGS. 6A and 6B, the associated game positions displaying playing card symbols 10a now display the BONUS image 40 and the stated prize amount of 150 credits, and the associated game positions displaying picture symbols 10b display the BONUS image 40 and the stated prize 42 of 750 credits.

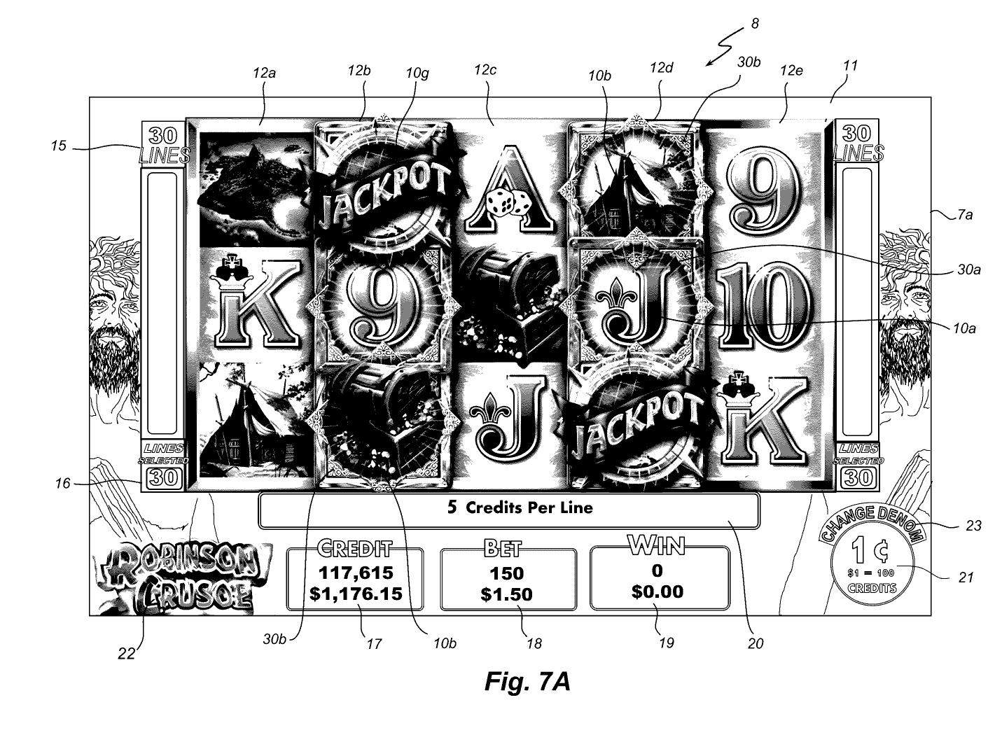

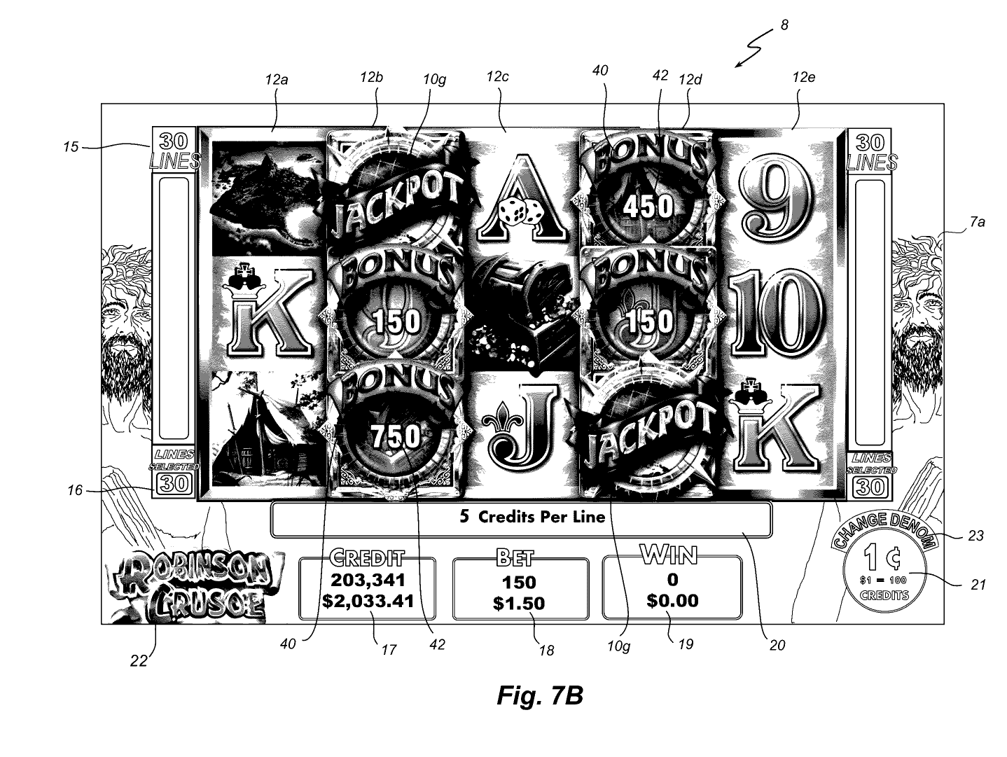

In FIG. 7A, the Jackpot symbol 10g has appeared in the top blue special game position 30b of the reel 12b and the bottom blue special game position 30b of the reel 12d. In response, the electronic game controller 4 causes the award of a prize for each of the game positions associated with the top and bottom blue special game positions 30b, being the other of the top and bottom blue special game positions 30b and the red special game positions 30a of reels 12b and 12d, as best shown in FIG. 7B. The playing card symbols 10a in two of the associated game positions results in the award of 150 credits for each playing card symbol, as indicated by the BONUS image 40 and the stated prize 42. The treasure chest picture symbol 10b in the bottom blue special game position 30b of reel 12b has a higher value than the value of the tent picture symbol 10b in the top blue special game position 30b of reel 12d. Accordingly, the prize awarded for the tent picture symbol 10b is only 450 credits, whereas the treasure chest picture symbol 10b results in a prize of 750 credits, as best shown in FIG. 7B.

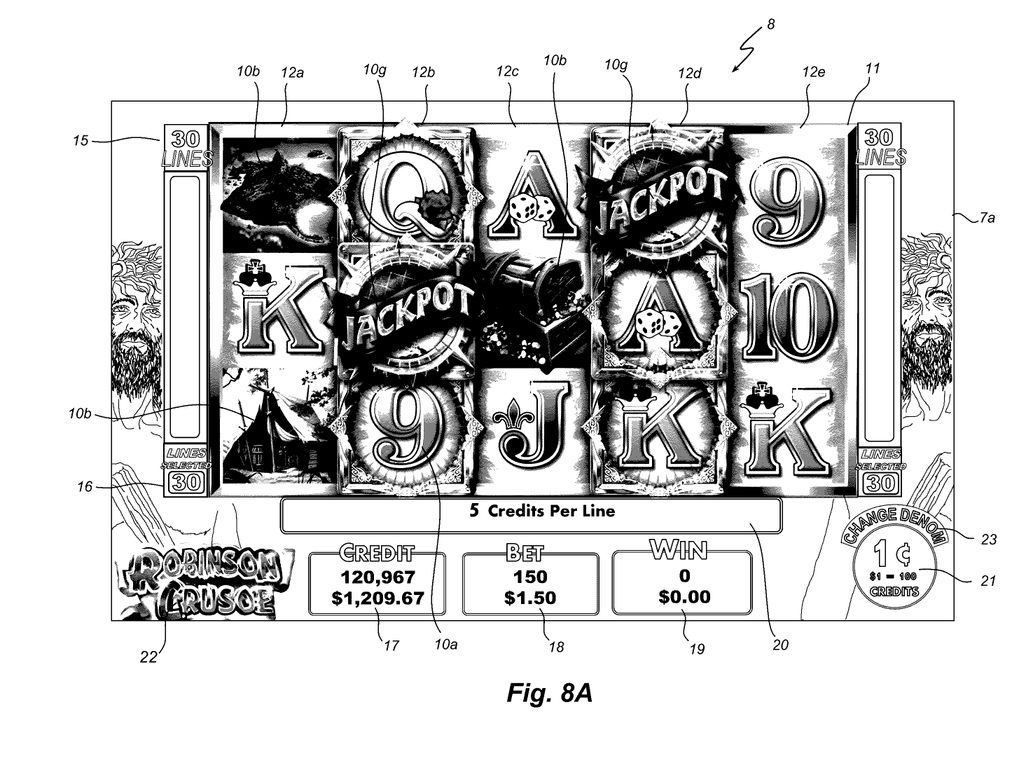

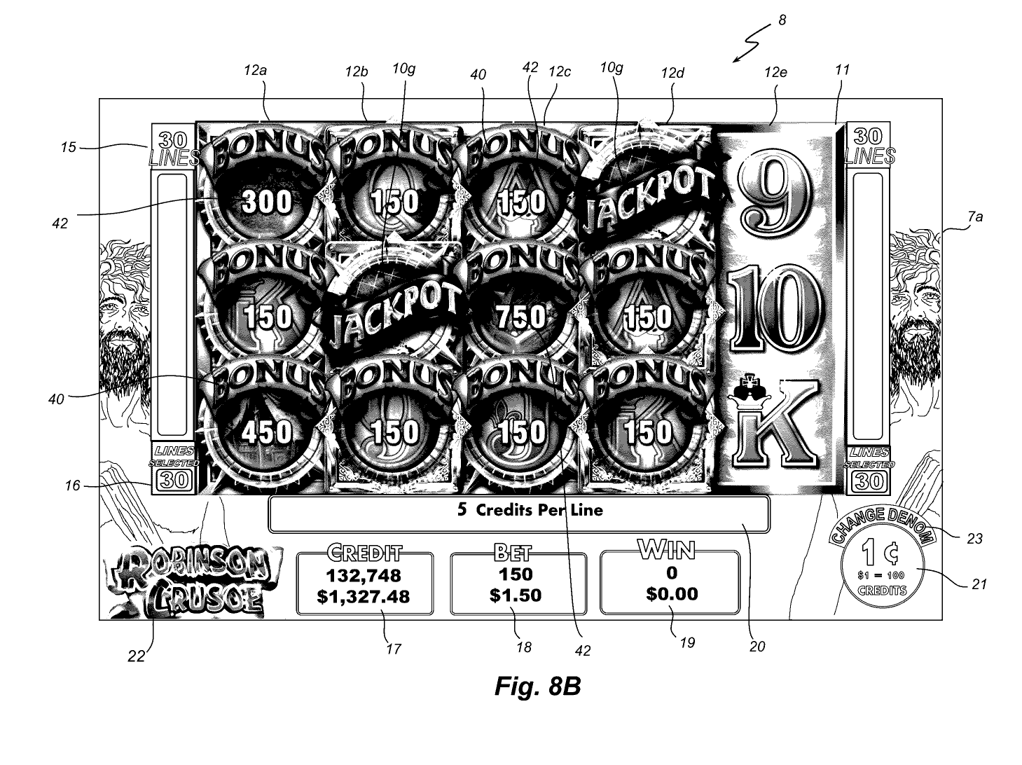

In FIG. 8A, the Jackpot symbol 10g has appeared in the top blue special game position 30b of the reel 12d and the red special game position 30a of the reel 12b. In response, the electronic game controller 4 causes the award of a prize for each of the game positions associated with the top blue special game position 30b, being the bottom blue special game position 30b and the red special game position 30a of reel 12d and the game positions associated with the red special game position 30a, being all the game positions 13 of reel 12a and 12c and the blue special game positions 30a of reel 12b, as best shown in FIG. 8B. The playing card symbols 10a in seven of the associated game positions results in the award of 150 credits for each playing card symbol, as indicated by the BONUS image 40 and the stated prize 42. The treasure chest picture symbol 10b in the middle game position 13 of reel 12c has a higher value than the value of the tent picture symbol 10b in the bottom game position 13 of reel 12a, which in turn has a higher value than the value of the island picture symbol 10b in the top game position 13 of reel 12a. Accordingly, the prize awarded for the island picture symbol 10 is 300 credits, the prize awarded for the tent picture symbol 10b is 450 credits and the prize awarded for the treasure chest picture symbol 10b is 750 credits, as best shown in FIG. 8B.

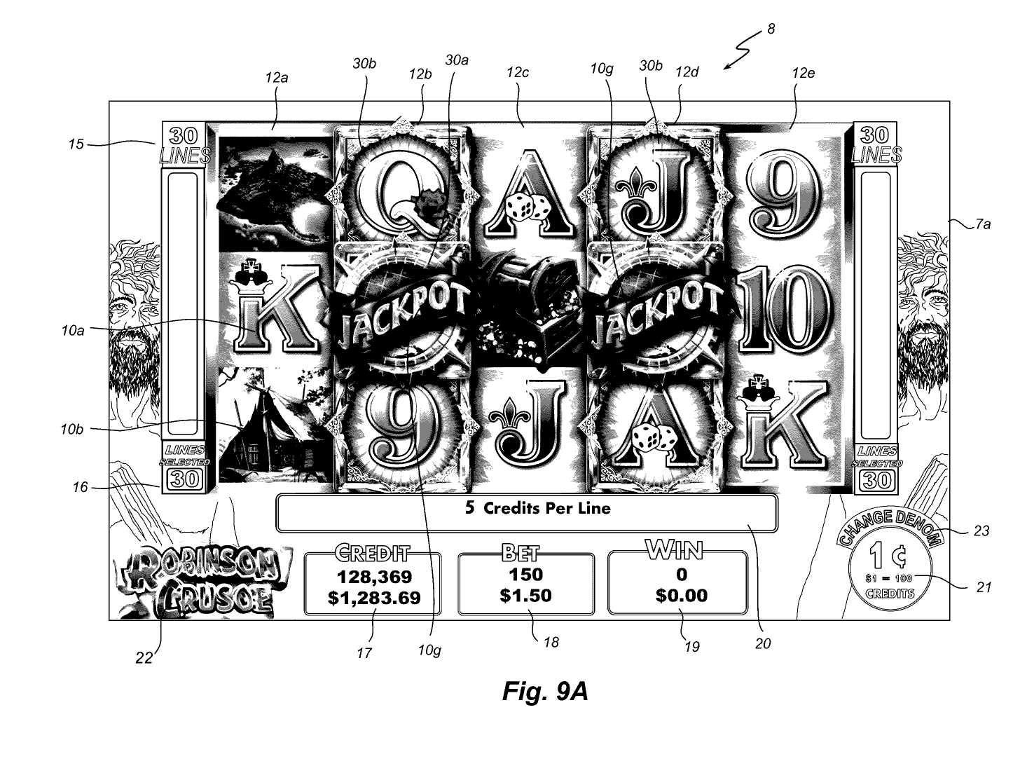

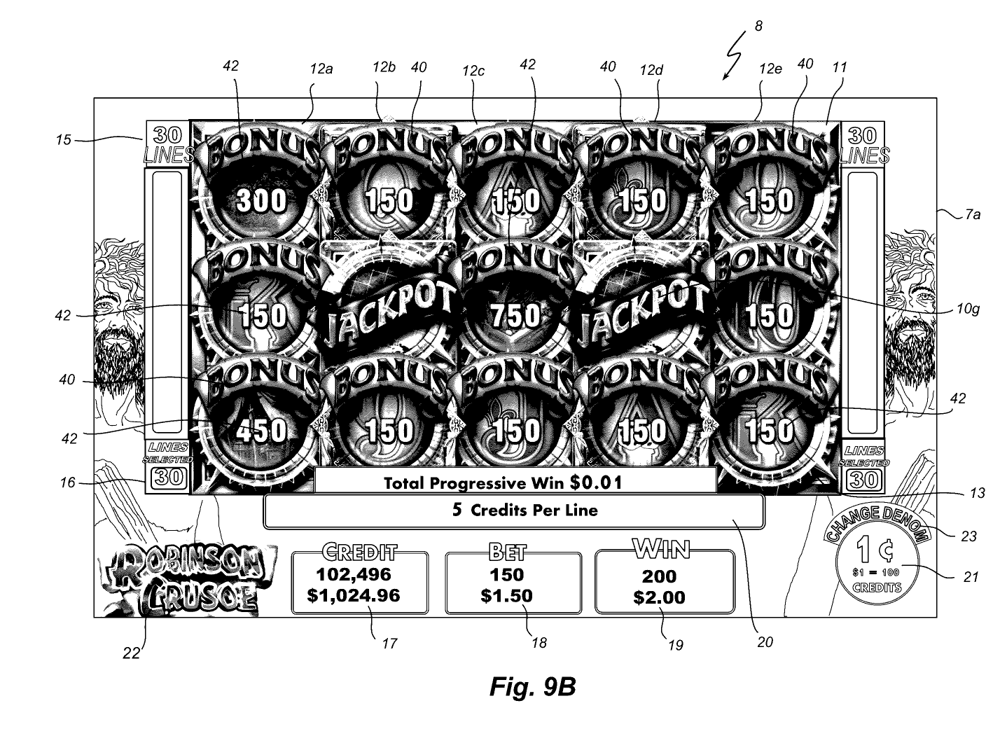

In FIG. 9A, the Jackpot symbol 10g has appeared in both red special game positions 30a of the reels 12b and 12d. In response, the electronic game controller 4 causes the award of a prize for each of the game positions associated with the red special game positions 30a, as best shown in FIG. 9B. For the red special game position 30a of the reel 12b, the associated game positions are all the game positions 13 of reel 12a and 12c, and the blue special game positions 30a of reel 12b. For the red special game position 30a of the reel 12d, the associated game positions are all the game positions 13 of reel 12c and 12d, and the blue special game positions 30a of reel and 12d. This effectively results in a prize being awarded for each game symbol 10 on the array 11, with the exception of the Jackpot symbols 10g. Again, the player card symbols 10a results in a prize of 150 credits, the island picture symbol 10 results in a prize of 300 credits, the tent picture symbol 10b results in a prize of 450 credits and the treasure chest picture symbol 10b results in a prize of 750 credits. The overlap in associated game positions 13 in reel 12c does not enhance the prize awarded, although in other embodiments the prize may be doubled or increased relative to the usual prize awarded. As before, each prize is accompanied by the BONUS image 40 and stated prize 42 superimposed over each game symbol 10 that remains partly visible.

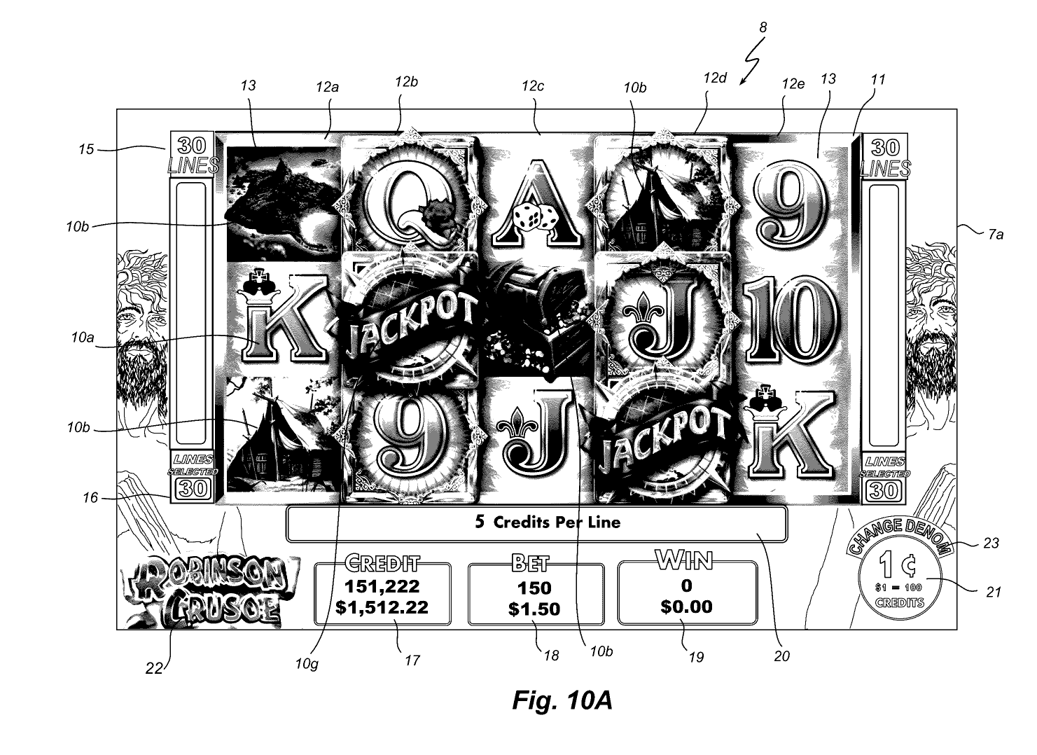

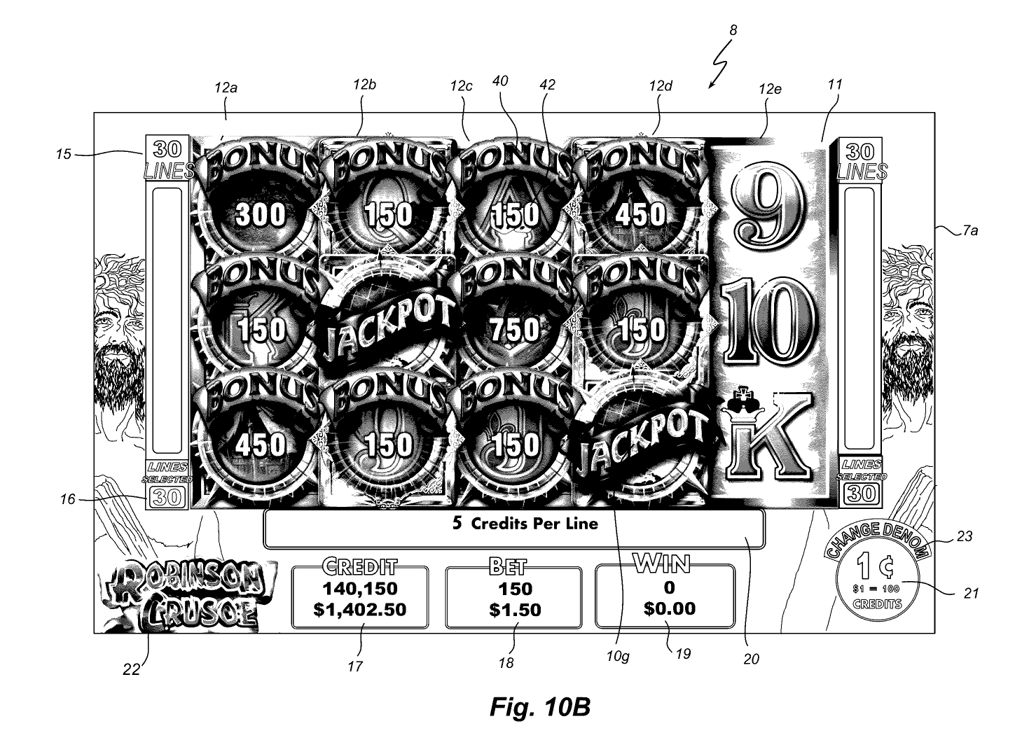

In FIG. 10A, the Jackpot symbol 10g has appeared in the red special game position 30a of the reel 12b and the bottom blue special game position 30b of the reel 12d. The associated game positions are therefore the game positions 13 of reels 12a and 12c, and the special game positions 30a, 30b of reels 12b and 12d, as best shown in FIG. 10B. The prizes awarded are the same as described above—150 credits for each playing card symbols 10a, 300 credits for the island picture symbol 10b, 450 credits for the tent picture symbol 10b and 750 credits for the treasure chest picture symbol 10b.

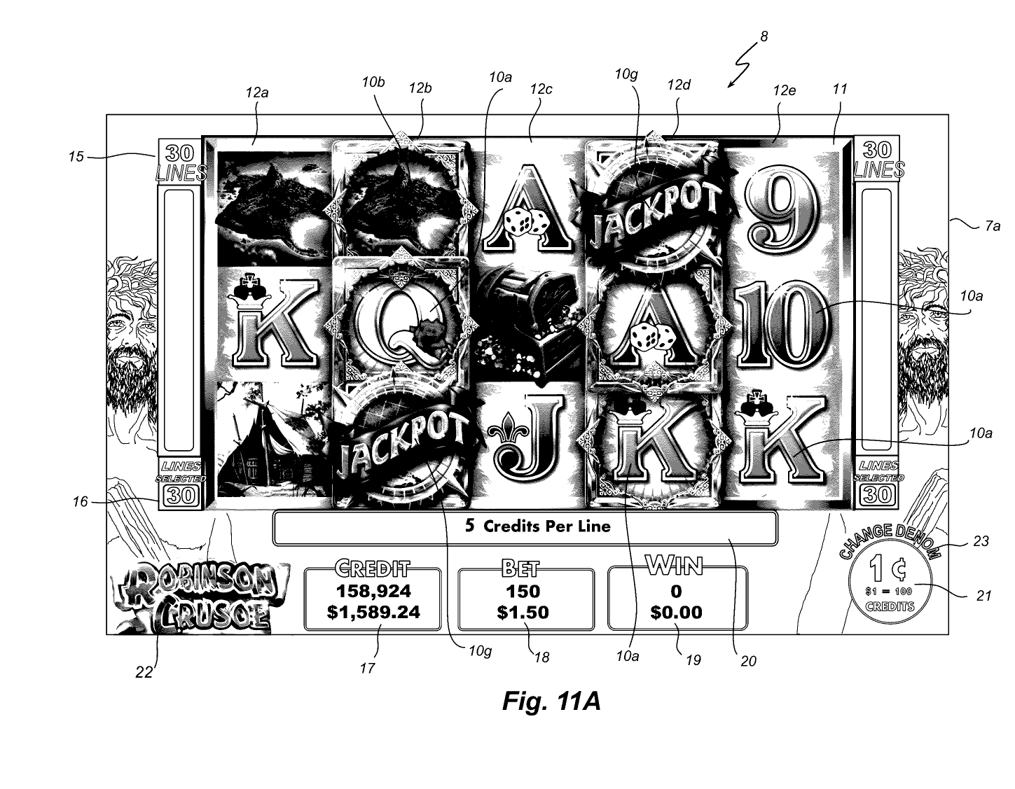

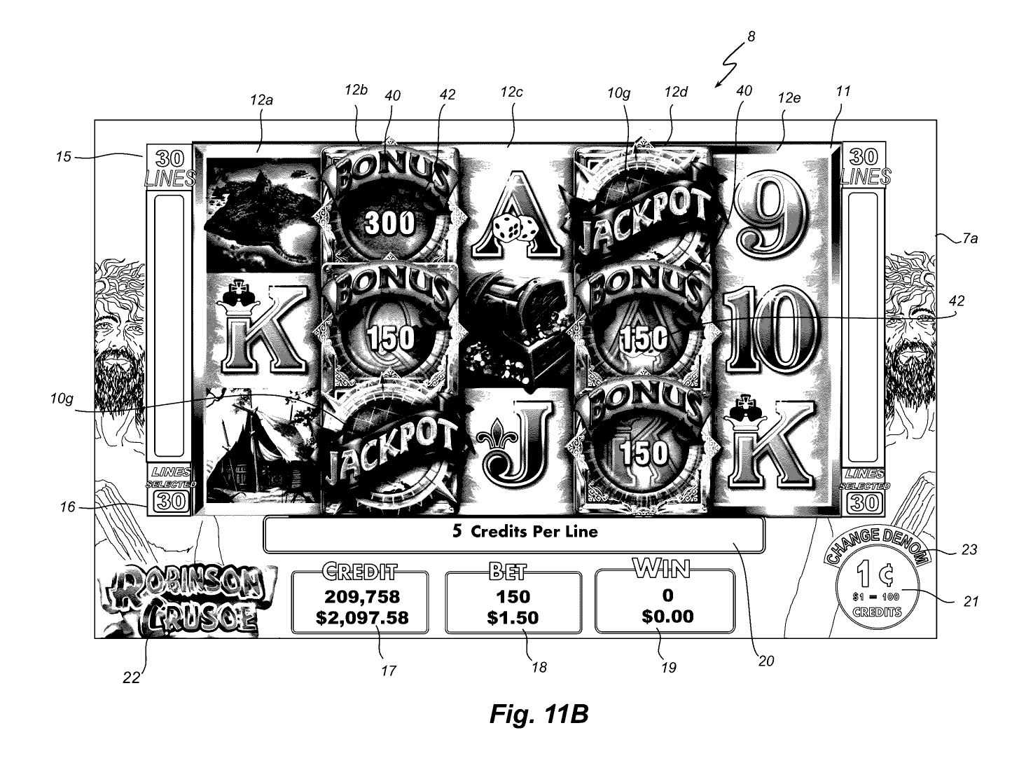

In FIG. 11A, the Jackpot symbol 10g has appeared in the bottom blue special game position 30b of the reel 12b and the top blue special game position 30b of the reel 12d. The associated game positions are therefore the blue special game positions 30b and the red special game positions 30a of reels 12b and 12d, as best shown in FIG. 11B. The prizes awarded are the same as described above.

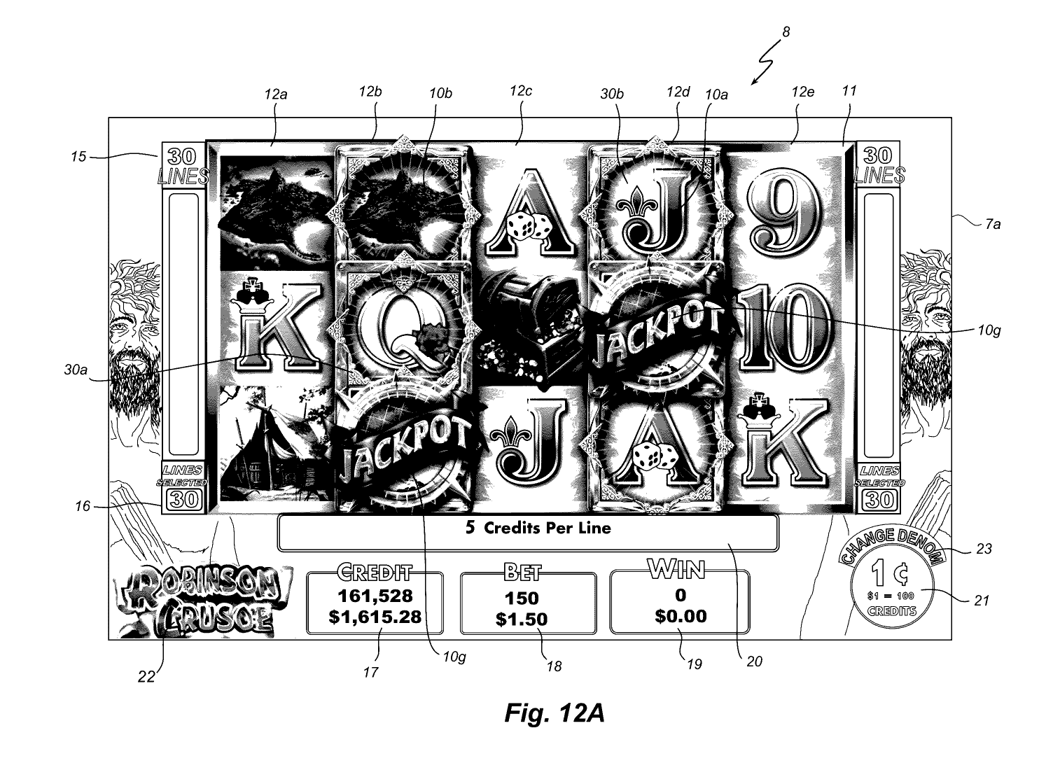

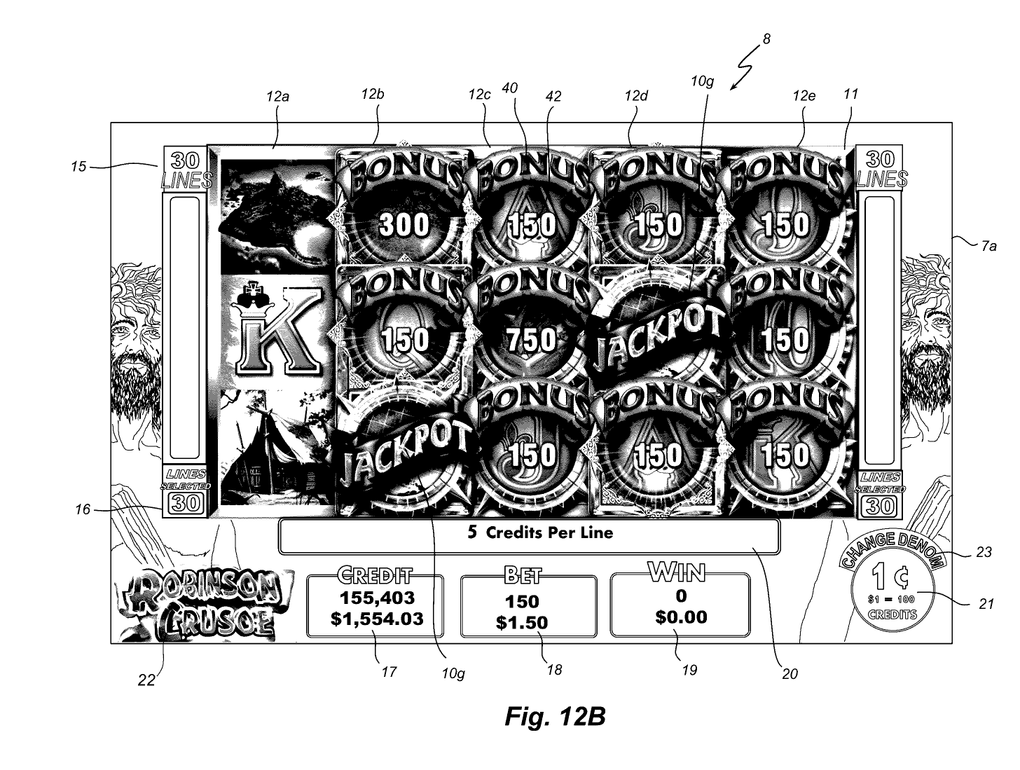

In FIG. 12A, the Jackpot symbol 10g has appeared in the bottom blue special game position 30b of the reel 12b and of the red special game position 30a reel 12d. The associated game positions are therefore the special game positions 30a, 30b of reel 12b, all the game positions 13 of reels 12c and 12e, and the special game positions 30a, 30b of reel 12d, as best shown in FIG. 12B. The prizes awarded are the same as described above.

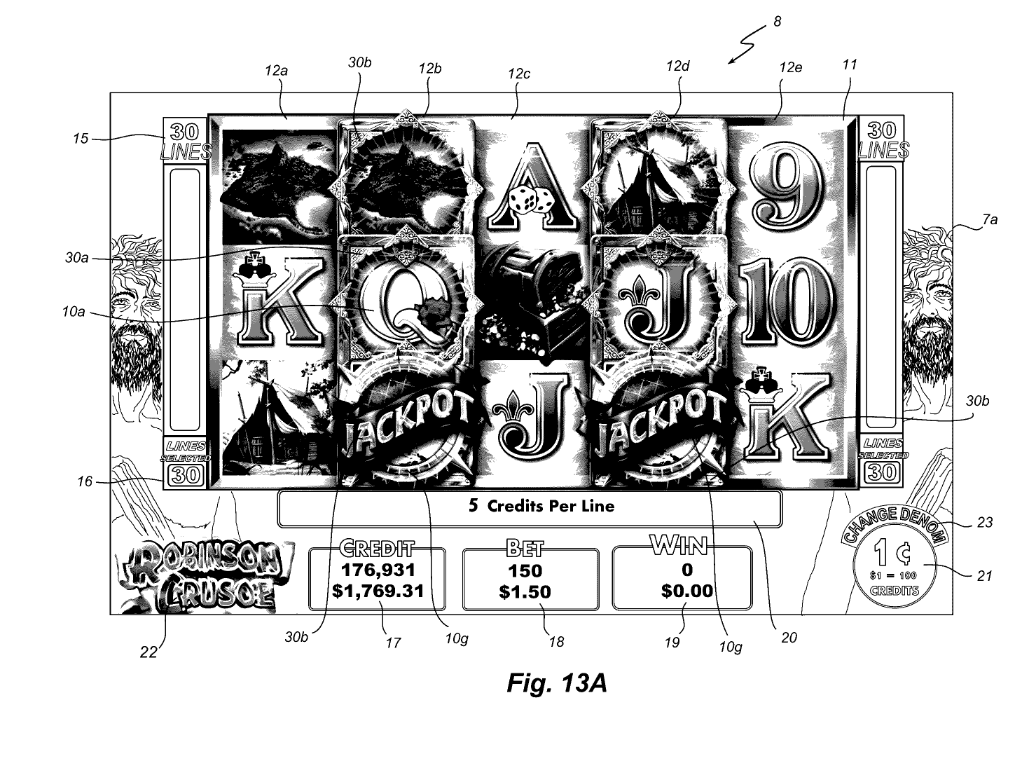

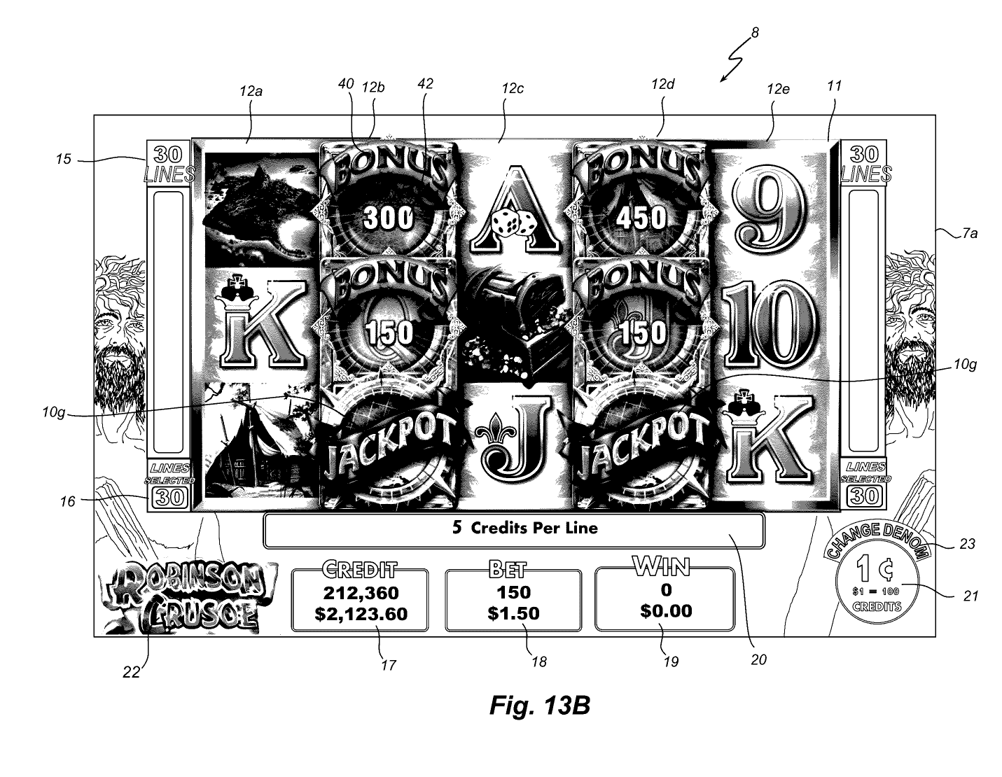

In FIG. 13A, the Jackpot symbol 10g has appeared in both bottom blue special game positions 30b of the reels 12b and 12d. The associated game positions are therefore the special game positions 30a, 30b of reels 12b and 12d, as best shown in FIG. 13B. The prizes awarded are the same as described above.

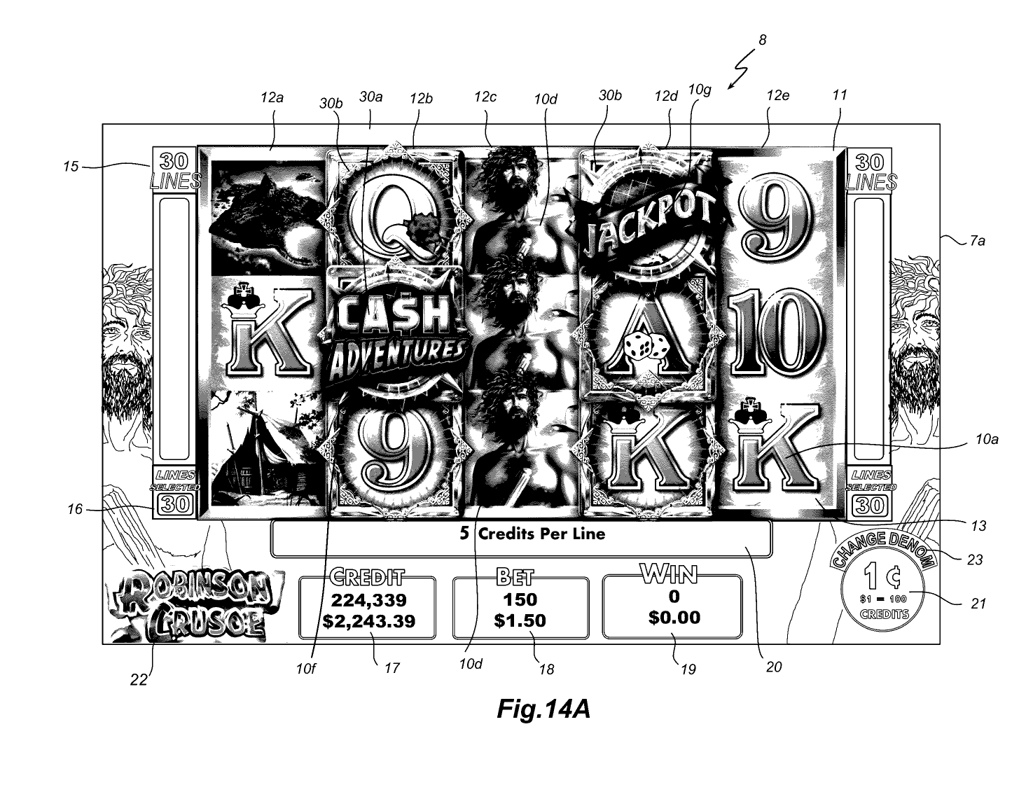

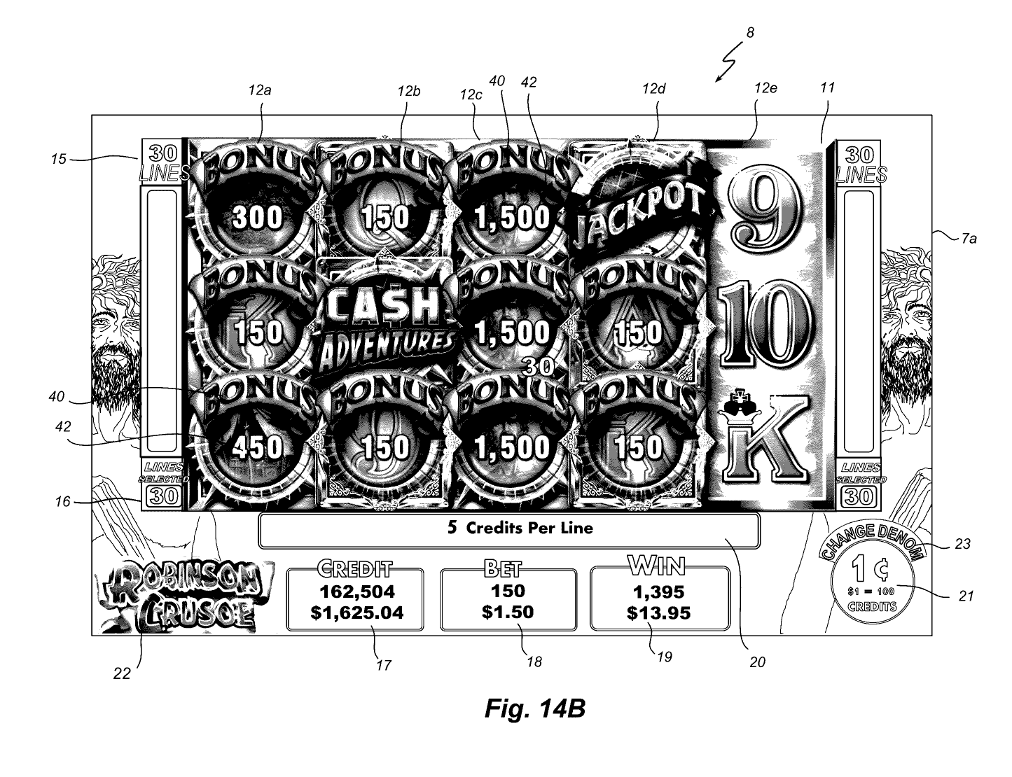

In FIG. 14A, the Cash Adventure symbol 10f has appeared in the red special game position 30a of the reel 12b and the Jackpot symbol 10g has appeared in the top blue special game position 30b of the reel 12d. The associated game positions are therefore the game positions 13 of reels 12a and 12c, and the special game positions 30a, 30b of reels 12b and 12d, as best shown in FIG. 14B. Aside from the usual prizes awarded for the playing card symbols 10a (150 credits), the island picture symbol 10b (300 credits) and the tent picture symbol 10b (450 credits), a prize of 1,500 credits has been awarded for each of the substitute Man symbols 10d that have appeared in each game position 13 of the middle reel 12c.

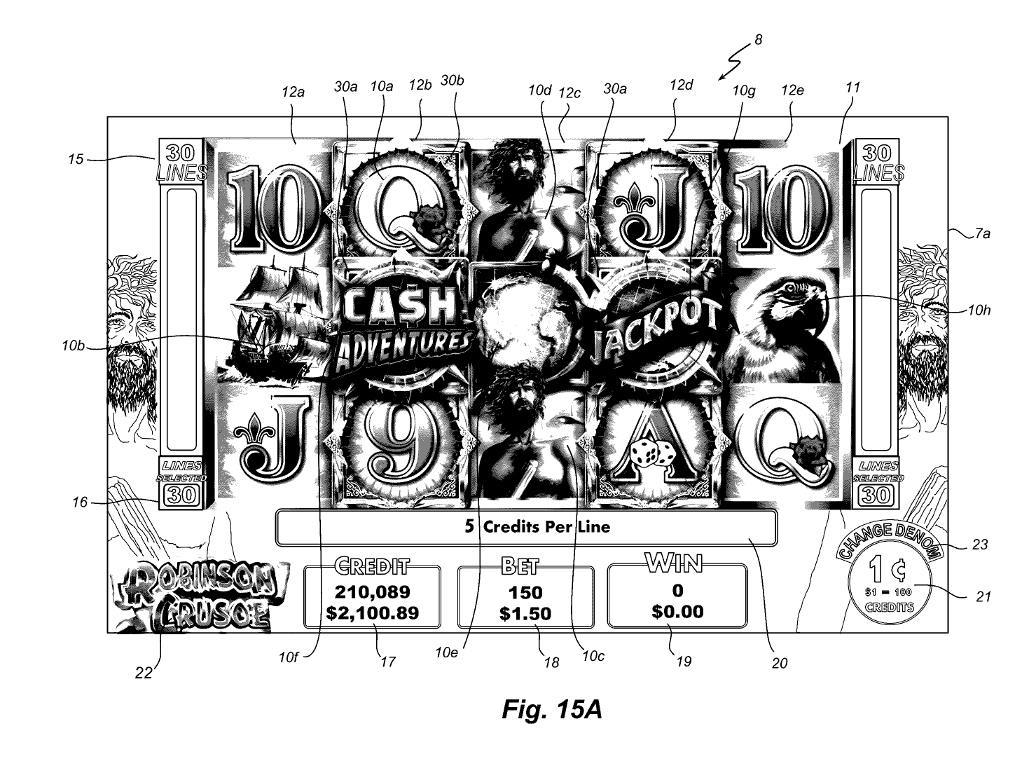

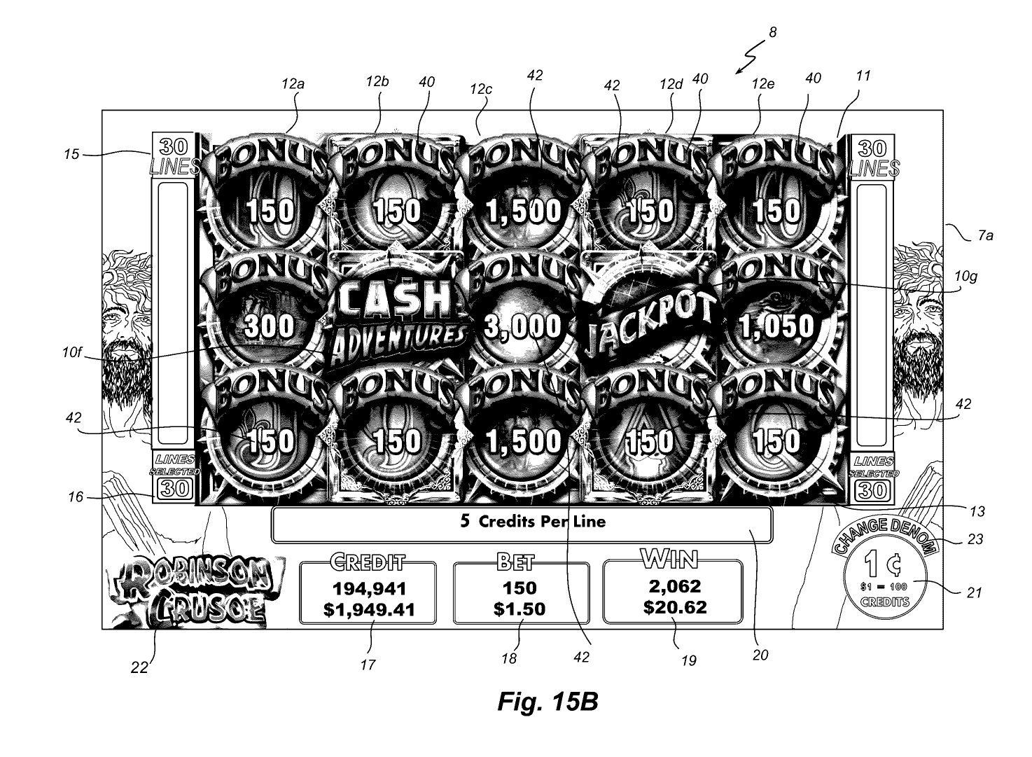

In FIG. 15A, the Cash Adventure symbol 10f and the Jackpot symbol 10g have appeared in both red special game positions 30a of the reels 12b and 12d. The associated game positions are therefore the game positions 13 of reels 12a, 12c and 12e, and the blue special game positions 30b of reels 12b and 12d, as best shown in FIG. 15B. As in FIG. 9, a prize is awarded for each game symbol 10 in the array 11 except for the Cash Adventure symbol 10f and the Jackpot symbol 10g. As described in relation to FIGS. 14A and 14B, a prize of 1,500 credits has been awarded for each of the substitute Man symbols 10d that have appeared in the top and bottom game position 13 of the middle reel 12c. In addition, a parrot symbol 12h appearing in the middle game position 13 of the end reel 12e has resulted in an award of 1,050 credits, while the substitute Gold Globe symbol 10e appearing in the middle game position 13 of the middle reel 12c has resulted in an award of 3,000 credits, indicating its relative value compared to the other game symbols 10.

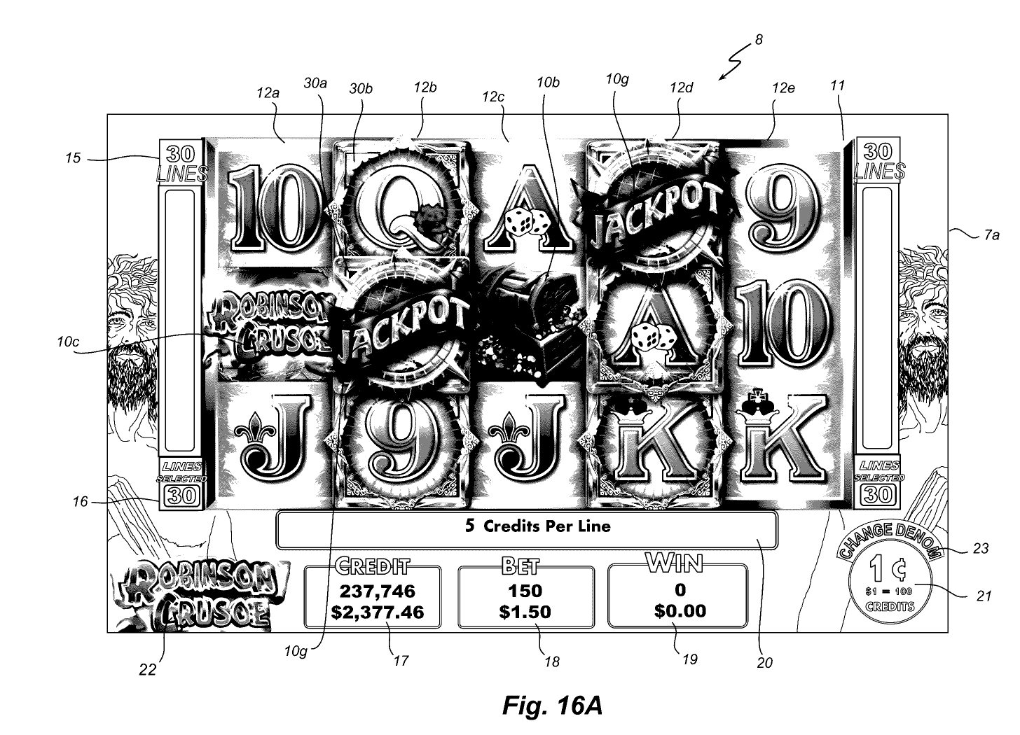

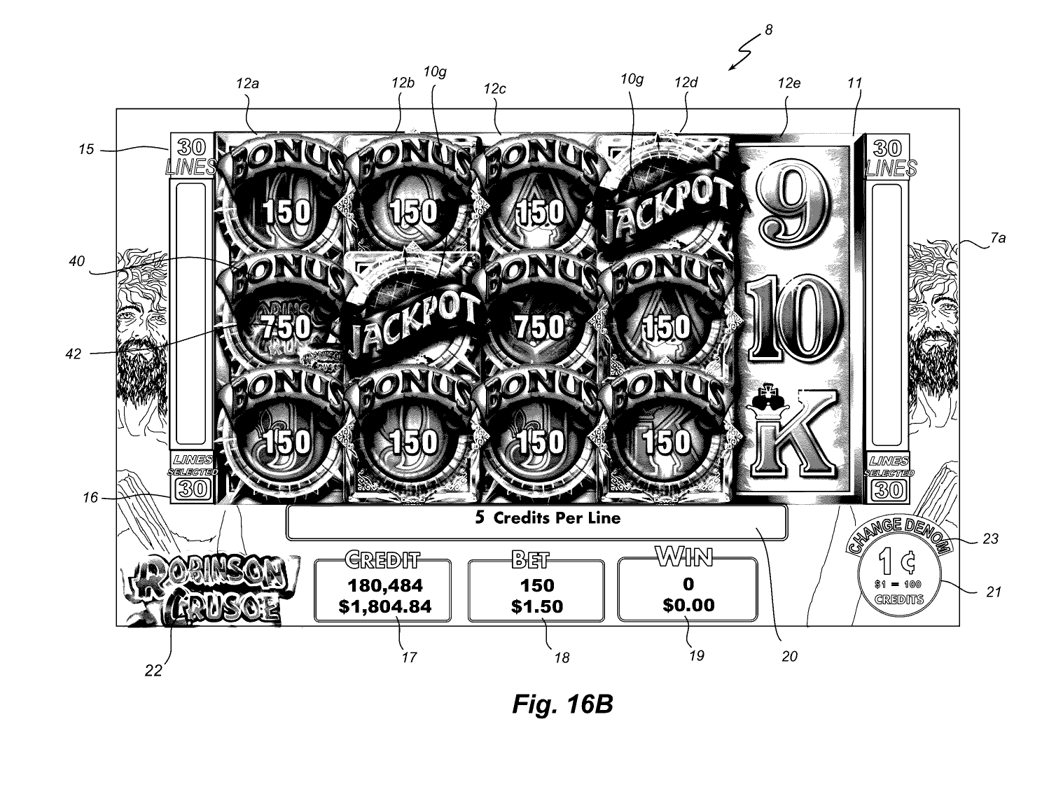

In FIG. 16A, the Jackpot symbol 10g has appeared in the red special game position 30a of the reel 12b and the bottom blue special game position 30b of the reel 12d. The associated game positions are therefore the game positions 13 of reels 12a and 12c, and the special game positions 30a, 30b of reels 12b and 12d, as best shown in FIG. 16B. The prizes awarded are the same as described above—150 credits for each playing card symbols 10a and 750 credits for the treasure chest picture symbol 10b. As a scatter Logo symbol 10c has appeared in the middle game position 13 of the left end reel 12a, a prize of 750 credits is awarded for this game symbol.

The relative values of the game symbols 10 are readily discernible by the player from the pay table for the base game 8 that can be accessed through the menu screen. In addition, the relative values of the prizes awarded via the special symbols correspond to the relative value of the associated game symbols 10 when they form standard winning combinations. For example, three of a kind of playing card symbols 10a will award a prize in the base game 8 that is less than the same three of a kind combination of the treasure chest picture symbols 10b. Hence, the prize awarded in response to a Cash Adventure symbol 10f or Jackpot symbol 10g appearing in a special game positions 30a, 30b will be higher for a treasure chest symbol 10b than a playing card symbol 10a appearing in the same associated game position. Similarly, the relative values of the remaining game symbols 10 can also be ascertained in this manner. In this embodiment, the prizes 42 are proportional to the value of the game symbol 10 displayed in the associated game position (i.e. a multiple of the game symbol value). In other embodiments, the game symbol values are multiplied by the same factor to obtain the prize 42. In some embodiments, each or some game symbol values are multiplied by the different factors to obtain the prize 42.

Furthermore, in the embodiment the prizes 42 are multiplied by the total credits bet to provide the final prize amount. The total credits bet is equal to the credits bet per pay line and the number of pay lines selected by the player. For example, a prize 42 of 3,000 credits as shown in FIG. 15B is multiplied by the total credits bet by the player for that play of the game. If the player has bet 100 credits (such as where 20 credits bet per pay line and 5 pay lines are selected), then the player is in fact awarded 300,000 credits. If the player has bet 20 credits (such as where 2 credits are bet per pay line and 10 pay lines are selected), then the player is awarded 60,000 credits. In other embodiments, the prize 42 is the same irrespective of the total credits bet by the player.

In addition, the electronic game controller 4 randomly determines whether a predetermined trigger event has occurred which triggers the feature game 9 on the electronic gaming machine 1. In this embodiment, the trigger event is the appearance of two Logo symbols 10c anywhere on the reels 12 without having to be on a player-selected pay line 14. In response to this trigger event, the electronic game controller 4 then causes the feature game 9 to be shown on the lower display area 7a of the screen 7, as best shown in FIG. 4. The jackpot and other game information remains shown in the upper display area 7b. However, it will be appreciated that in other embodiments, the feature game 9 can be shown to occupy the entire screen 7 or in the upper display area 7b. Where the feature game 9 occupies the entire screen, it may use an enlarged or extended array that has substantially more symbol positions 13 than the array 11 in the base game 8.

The feature game 9 uses the same array 11, same game symbols 10, reels 12a to 12e, symbol positions 13 and pay lines 14 from the base game 8. In the feature game 9, eight free plays or spins of the reels 12 are awarded to the player. It will be understood by those skilled in the art that a free spin involves a play of the game without requiring any bet to be made by the player, and that any number of free spins can be chosen for the feature game. In addition, it will be appreciated that in the art free spins are commonly referred to as “free games”. The number of free spins left in the feature game 9 is indicated in a counter 35, as best shown in FIG. 4.

The feature game 9 operates in a similar manner to the base game 8, where the reels 12 visibly rotate and display randomly selected game symbols 10 in each game position 13, including the special game positions 30a, 30b, as best shown in FIG. 4. The special game positions 30a, 30b are visually indicated or marked by their respective boundaries 31a, 31b from the start to the end of each play of the feature game 9, the same as in the base game 8. Predetermined winning combinations of randomly selected game symbols 10 in the array 11 of the feature game 9 also result in the award of prizes to the player, usually of an enhanced value compared to the prizes awarded in the base game 8. In the feature game 9, the appearance of two Logo symbols 10c causes the addition of five free spins to the feature game.

The special symbols 10f, 10g and the special game positions 30a, 30b still operate in the same way in the feature game 9 as in the base game 8. Thus, the additional prizes can be awarded as part of the feature game 9 as well as the base game 8. However, in other embodiments, the use of special symbols 10f, 10g and the special game positions 30a, 30b is limited to either the base game 8 only or the feature game 9 only.

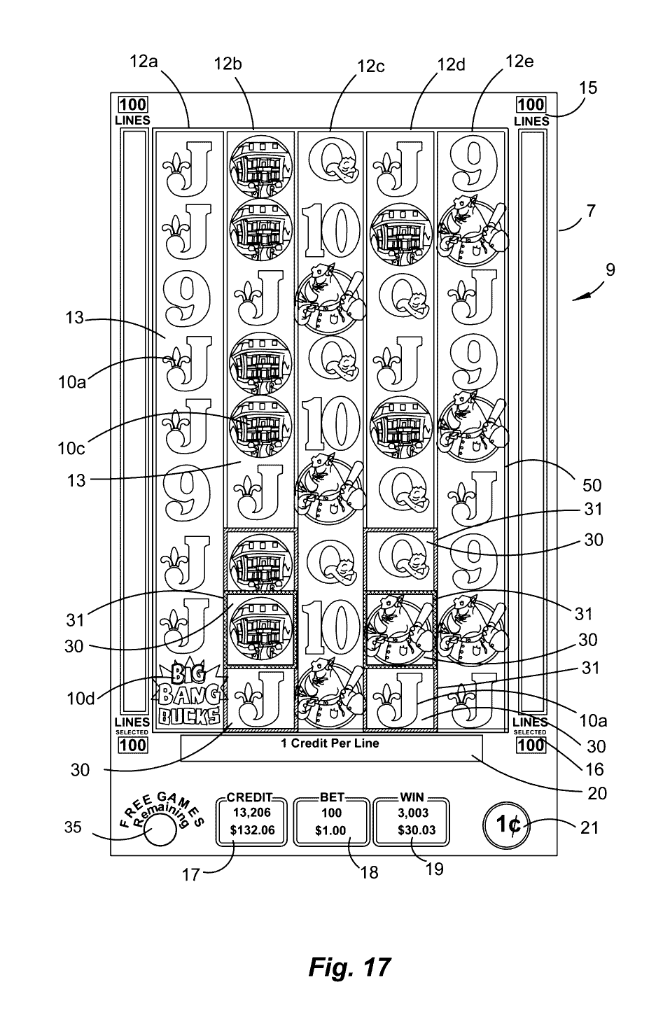

Also in the feature game 9, where the Cash Adventure symbol 10f appears once on either reel 12b or 12d, the remaining reels are respun to provide another opportunity to obtain a winning combination, retrigger the award of five additional free games or trigger the award of the prizes 42. Where the Cash Adventure symbol 10f appears once on reel 12b, the remaining reels 12a, 12c, 12d and 12e are respun. Where the Cash Adventure symbol 10f appears once on reel 12d, the remaining reels 12a, 12b, 12c and 12e are respun.

Where the array in the feature game 9 is larger than the array 11 in the base game 8, such as providing additional rows to create extended reels (i.e. reels with more game positions 13) the special game positions 30 in reels 12b, 12d do not change but remain in the same positions as in the base game array 11, as best shown in FIG. 17, which illustrates an alternative embodiment of the invention. The extended array 50 comprises five columns or reels having nine rows—a 5×9 array In this case, the prizes are awarded for all the game symbols 10 displayed in the game positions 13 in the extended reels. For example, using the embodiment of FIGS. 5A to 16B, where a Jackpot symbol 10g appears in the middle red game position 30 of the reel 12b, the electronic game controller 4 may cause a prize to be awarded for each game symbol displayed in all the game positions in the reel 12b and all the game positions in the adjoining reels 12a, 12c on either side, irrespective of their length (number of game positions). It will also be appreciated that an extended array like array 50 need not be limited to the feature game 9, but can be used in the base game 8.

In other embodiments, the graphical element 31 comprises an area on the array 11 associated with each special game position 30a, 30b that changes to indicate the appearance of the Cash Adventure symbol 10f or Jackpot symbol 10g in the special game position. For example, message boxes (not shown) can appear adjacent the array 11 and linked to the special game positions 30a, 30b that are initially blank and then advise the player when the Cash Adventure symbol 10f or Jackpot symbol 10g appears in a special game position 30a, 30b. Also, there can be a common message box for all the special game positions 30a, 30b and the message advising the player which special game position 30a, 30b has the Cash Adventure symbol 10f or Jackpot symbol 10g.

In another embodiment, special game position 30 may be animated in other ways other than animating the boundary 31. For example, the special game position 30 could rotate about the Cash Adventure symbol 10f or Jackpot symbol 10g. Alternatively, the boundary 31 can be animated differently to having a chaser light move along its perimeter. For example, the boundary 31 could be animated to show it is electrified to visually highlight and indicate its presence on the array 11.

In yet another embodiment, the Cash Adventure symbol 10f or Jackpot symbol 10g is animated when it appears in the special game position 30a, 30b to visually indicate its appearance to the player. For example, the Cash Adventure symbol 10f or Jackpot symbol 10g may be static in game positions 13 but in the special game position 30, the Cash Adventure symbol 10f or Jackpot symbol 10g becomes animated.

In other embodiments, the frequency (and thus appearance) of the feature game trigger symbol and/or special symbol may depend on the bet option selected by the player and/or the total credits bet in a play of the base game 8. For example, selecting a bet option of 20 credits bet per pay line may make the Logo symbol 10c, the Cash Adventure symbol 10f and/or Jackpot symbol 10g have a higher frequency of appearing on the reels 12a to 12e during play of the base game 8 and/or feature game 9, in order to increase the chance of triggering the feature game 9 and/or award of the prizes 42 during game play compared to a bet option of only 3 credits bet per pay line. In another example, the probability of the Jackpot symbols 10g appearing on reels 12b, 12d (and thus appear in special game positions 30a, 30b) to trigger the award of a jackpot prize increases as the total credits bet increases. Thus, for a total credits bet of 10 credits (2 credits bet per pay line and 5 selected pay lines) the frequency of the Jackpot symbols 10g appearing on the reels 12b, 12d is less than the frequency of Jackpot symbols 10g appearing on the reels 12b, 12d for a total credits bet of 500 credits (20 credits bet per pay line and 25 selected pay lines). Where the total credits bet is the maximum amount of 1,000 credits (20 credits bet per pay line and 50 selected pay lines), in this embodiment the Jackpot symbol 10g is guaranteed to appear on reels 12b, 12d. The variation in the appearance of Jackpot symbols 10g is controlled by using different reels strips for the reels 12 depending on the total credits bet. Thus, for the total credits bet of 500 credits, the reels 12b, 12d use reel strips containing more Jackpot symbols 10g than the reel strips used when the total credits bet is only 10 credits. This enables the player to tailor or customize how the base game 8 plays by simply increasing the total credits bet to increase the chance of winning a jackpot prize. In other embodiments, the probability of the Jackpot symbols 10g appearing on the reels 12b, 12d depends on the credits bet per pay line or the number of pay lines selected.

The jackpots offered by the electronic gaming machine 1 may include progressive jackpots, fixed jackpots, mystery jackpots and symbol driven jackpots. Also, other bonus prizes can be awarded by the electronic gaming machine 1. In other embodiments, the jackpots are limited to the base game 8 or the feature game 9 only. A progressive jackpot prize takes a portion of each bet (typically a set percentage of each bet) made on the electronic gaming machine and thus the amount of the progressive jackpot incrementally increases as more bets are made on the electronic gaming machine 1. The progressive jackpot is typically awarded when a winning game combination associated with the jackpot occurs in the game played on the electronic gaming machine. In many cases, progressive jackpots are associated with the least probable winning combination and are commonly the highest paying award of the electronic gaming machine. In other cases, a separate trigger event can be used to award the progressive jackpot prize, such as a special jackpot symbol, a trigger event internally generated by the electronic game controller. Alternatively, or additionally, once a certain threshold is met, either a certain amount that has been bet on the electronic gaming machine or the incremented amount of the progressive jackpot, a trigger event is activated in the electronic gaming machine to pay out the progressive jackpot prize. Progressive jackpot prizes also tend to be shared amongst multiple electronic gaming machines so as to increase the amount of the progressive jackpot prize and hence increase player interest in playing one of the electronic gaming machines. In some electronic gaming machines, more than one jackpot or progressive jackpot is offered by the electronic gaming machine or electronic gaming machines linked together.

The jackpot or bonus prizes may also be mystery jackpots rather than symbol driven jackpots. That is, none of the symbols in the game trigger the jackpot; hence the trigger event is a “mystery”. By way of comparison, a standard jackpot is typically symbol driven in that a particular combination of symbols must occur in the game to trigger the standard jackpot.

The trigger event for the mystery jackpot can be one randomly generated by the electronic game controller 4 for each play of the base game 8 and/or feature game 9. One way to implement the random determination of the trigger event is for the electronic game controller 4 to internally generate a random number and check if it is a predetermined number or within a predetermined range of numbers that will initiate the appearance of the trigger symbols. For example, the predetermined range of numbers could be the range of numbers between 1 and 10 and the electronic game controller 4 internally generates a random number between 1 and 100. If the generated number is any one of numbers 1 to 10, then this results in the electronic game controller 4 causing the trigger event to occur and award the progressive jackpot prize. It will be appreciated that this manner of determining the trigger event may also be used to determine whether the feature game 9 is triggered in the base game 8.

Progressive jackpots can be confined to the electronic gaming machine 1 as so called “standalone” progressive jackpots. Alternatively, the jackpot is a wide area or an in-house linked progressive jackpot prize. In other embodiments, one or more the progressive jackpot prizes are configured to be part of a wide area or in-house linked progressive jackpot prize. In other words, the progressive jackpot prizes can be awarded on a group of networked gaming machines in a specified area or a group of specified electronic gaming machines that are linked together for jackpot purposes (usually via a central jackpot controller). The jackpot prizes can also be shared with any other games offered on the same electronic gaming machine 1 (as in multi-game gaming machines).

During play of the base game 8 and/or feature game 9, the electronic game controller will determine whether a trigger event for any of the jackpots has occurred, as described above. In response to the occurrence of the jackpot trigger event(s), the electronic game controller 4 transmits a signal to the video screen 7 to cause the jackpot(s) associated with the jackpot trigger event(s) to be awarded to the player. After the jackpot(s) are awarded, their values are reset and game play of the electronic gaming machine 1 continues as before. The values of the jackpots that have been won can be reset either to a predetermined start value or simply increment upwardly from zero where the won jackpot is a progressive jackpot. In addition, contributions of portions of the bet made to play the game are only made for the jackpots that are active. In this way, the player's bets do not contribute towards jackpots that the player cannot win.

In other embodiments, the in-game trigger event is determined at the end or during the play of the game; i.e. at the end or during a spin of the reels 12. In some embodiments, the in-game trigger event occurs in a preceding play of the game so that the jackpot or other result of the in-game trigger event takes place in a subsequent play of said game, typically the next play of the game after said preceding play but could include a later successive play of the game.

As briefly described above, in the embodiment of FIGS. 3 to 16B, the Jackpot symbol 10g is used to trigger the award of jackpot prizes during play of the base game 8 or feature game 9. The mini, minor, major and grand jackpots are standalone progressive jackpots in this embodiment. However, the jackpots may be different in other embodiments as described above.

Where one Jackpot symbol 10g appears in one of the blue special game positions 30b of the reel 12b and one Jackpot symbol 10g appears one of the blue special game positions 30b of the reel 12d (as best shown in FIGS. 5A, 7A, 11A and 13A), then the mini jackpot is awarded in addition to triggering the award of the prizes 42 as described above. Where one Jackpot symbol 10g appears in the red special game position 30a of the reel 12b and one Jackpot symbol 10g appears one of the blue special game positions 30b of the reel 12d (as best shown in FIGS. 6A, 8A, 10A and 12A), then the minor jackpot is awarded in addition to triggering the award of the prizes 42. Where the Jackpot symbol 10g appears in each of the red special game positions 30a of the reels 12b, 12d (as best shown in FIG. 9A) and the Gold Globe symbol 10e does not appear in the reel 12c, then the major jackpot is awarded in addition to triggering the award of the prizes 42. Where the Jackpot symbol 10g appears in each of the red special game positions 30a of the reels 12b, 12d and the Gold Globe symbol 10e appears in the reel 12c, then the grand jackpot is awarded in addition to triggering the award of the prizes 42.

In one embodiment, the associated game positions 13 are limited to one of the reels 12 adjacent or adjoining the reel containing the Cash Adventure symbol 10f or Jackpot symbol 10g in the special game position 30a, 30b. The associated game positions can also exclude the reel containing the Cash Adventure symbol 10f or Jackpot symbol 10g in the special game position 30a, 30b.

Also, while in the embodiment the same special game position 30a, 30b awards prizes for the same group of associated game positions in the base game 8 and the feature game 9, in another variation, the associated game positions vary between the base game 8 and the feature game 9 for the same special game position 30a, 30b.

In a further embodiment, the location of the special game positions 30a, 30b change between the base game 8 and the feature game 9. For example, the special game positions 30a and/or 30b can be located in reels 12a and 12c in the base game 8, and then move to reels 12b and 12d in the feature game 9. Also, the special game positions 30a, 30b may change between plays of the game (either the base game 8 or the feature game 9). This can be either successively or after a predetermined number of plays in one location, the special game position 30a and/or 30b moves to another location on the array 11.

Another embodiment involves scattering the location of the special game positions 30a, 30b in the array 11 instead of being grouped together in a particular reel 12. For example, instead of having special game positions 30a, 30b in reels 12b, 12d, the six special game positions 30 can be placed so that there is at least one special game position in each reel 12a to 12e of the array 11. In yet another embodiment, additional special game positions 30 are provided where the array is larger in the feature game 9.

In yet another embodiment, the boundaries 31a, 31b may only appear on their respective special game positions 30a, 30b once a play of the base game 8 commences and remain on display until the end of that play. Alternatively, the boundaries 31a, 31b are permanently displayed on their respective special game positions 30a, 30b at all times on the video screen 7.

In other embodiments, the electronic gaming machine 1 also offers the player the opportunity to play in community games against other players in so-called tournament games, or even in player versus player games. This is typically implemented by electronically linking several electronic gaming machines 1 in a group within a gaming venue. The player versus player or tournament game can be played simultaneously by the players or can be staggered, with some players playing at one time and some players playing at another time in the same game. In this situation, the player versus player or tournament game comprises the award of an additional bonus prize in addition to the jackpot prizes in said selected available jackpot set.

It will be appreciated that in other embodiments, game enhancing elements can be awarded in the base game 8 or feature game 9 in addition or as an alternative to the prizes awarded based on winning combinations of game symbols. The award of game enhancing elements can be done by way of a sixth reel or the appearance of game enhancing symbols in the reels 12a to 12e. In other embodiments, the appearance of the special symbol (either, the Cash Adventure symbol 10f, Jackpot symbol 10g or a new special symbol) in a special game position 30a, 30b may also confer the game enhancing element upon the player. The game enhancing elements that are awarded may depend on whether the special symbol has appeared in a blue special game position 30b or a red special game position 30a. Generally, a higher value game enhancing element is awarded for the special symbol appearing in a red special game position 30a than the game enhancing element is awarded for the special symbol appearing in a blue special game position 30b.

A variety of game enhancing elements can be awarded by the game enhancing symbols, including:
i) symbols that award a predetermined number of free plays of said game, such as 8, 10 or 15 free spins or games;
ii) win multiplier symbols that multiply the amount of any win from one of said predetermined winning combinations;
iii) “wild” symbols that cause the display of substitute symbols in randomly selected symbol positions;
iv) wild multiplier symbols that cause the display of substitute symbols on the array 25 and multiplies the amount of any win from one of said predetermined winning combinations;
v) bonus wild symbols that cause the display of substitute symbols on the array 25 and awards a bonus prize;
vi) symbols that cause the award of additional free plays of said game;
vii) symbols that cause one or more of said symbol positions to be held static (typically one or more reels 12a to 12e) and display substitute symbols on the array 25;
viii) symbols that cause the same game symbol to be stacked in a group of symbol positions, typically the group being one or more reels 12a to 12e;
ix) symbols that cause the display of new game symbols on the array 25;
x) “reveal” symbols that cause a game symbol to reveal another game symbol;
xi) “replacement” symbols that cause one or more game symbols to be replaced by other game symbols in the array 25;
xii) bonus prize of 5× bet, 10× bet or 25× bet (the total amount of the bet or credits bet per pay line);
xiii) all royal card symbols change to wilds (substitute symbols) on reels 12b, 12c and 12d (usually called reels 2, 3 and 4, respectively) of the array 25;
xiv) all picture symbols change to wilds on reels 2, 3 and 4 of the array 25;
xv) all symbols on reels 2 and 4 of the array 25 change to wild symbols; and
xvi) all symbols on reels 12a and 12e (usually called reels 1 and 5, respectively) of the array 25 change to wild symbols.

These game enhancing symbols do not modify the function or value of the game symbols 10 that appear on the array 11, but instead confer bonus prizes, free games or change existing game symbols for other game symbols (such as replacing picture, royal card or symbols belonging to a reel with wild/substitute symbols). Where the function of game symbols 10 have been changed or the game symbols 10 are replaced, then this modification can take effect with the next play of the game instead of applying to the result of the spun reels 12. In another embodiment, the game enhancing symbols may indicate the duration in which its game enhancing element is applied, such as a predetermined number of spins or a predetermined time period.

While the same game format is essentially used across the base game 8 and feature game 9, it will be appreciated that the game format may vary across the base and feature games, as well as between base games where more than one game is offered by the same electronic gaming machine 1. For example, one of the base and feature games may be a wheel-type game or a four reel game and another of the base and feature games may be a standard five reel game. Similarly, the base and feature games may each have different game symbols, game rules and pay tables that are unique to each game.

While one embodiment of the invention has been described in relation to a base game 8 and a feature game 9, it will be appreciated that the invention could include one or more additional feature and/or bonus games that are triggered by specific trigger symbols appearing in the feature game 9. Also, the additional feature or bonus games may also have trigger symbols that trigger further feature or bonus games in a cascading fashion. These additional and further feature or bonus games could have the same game play elements as the feature game 9 or be different feature or bonus games entirely. The ability to accumulate bonus game tokens may be available in these additional feature or bonus games or only some of these additional games, with or without requiring a further bet to be made.

Furthermore, the embodiments of the invention have been described as providing a standard 5×3 set of reels 12 for the base game 8. However, it will be appreciated that in other embodiments, the size and shape of the reels 12 may vary for the base game 8 and/or the feature game 9. For example, the arrays 11 could take any number of different shapes, such as triangular, circular, square, hexagonal, hemi-spherical or other non-rectangular or polygonal shapes. In another example, where the array is circular, the symbol positions 13 can take the form of pie-shaped slices or wedges. Also, the array 11, 50 could have any number of rows and columns. Alternatively, the array 11 could have an unequal number of rows and/or columns. For example, the reels 12a, 12b could have three rows, but the reels 12c to 12e could have four rows.

In another embodiment, the player is required to bet on predetermined patterns or “ways”, instead of a number of pay lines 14. That is, the predetermined winning combinations are defined by a plurality of combinations of game positions 13 and these game position combinations are formed into two or more groups of combinations selectable by the player. Generally, groups having more game position combinations will attract a higher bet than groups have less game position combinations. For example, for an industry standard set of five reels with three rows each, there are 243 unique combinations of symbol positions 13, each combination comprising a pattern or “way”. Thus, the electronic game controller can provide bet options based on the number of ways and hence the amount bet per way.

In a further embodiment, the appearance of a Cash Adventure symbol 10f or Jackpot symbol 10g appears on the array 11, the reels 12 that do not have the Cash Adventure symbol 10f or Jackpot symbol 10g are respun to increase the chances of the Cash Adventure symbol 10f or Jackpot symbol 10g appearing in one of the special game positions 30a, 30b and hence triggering the award of the prizes 42. In a further variation, the Cash Adventure symbol 10f or Jackpot symbol 10g must appear in one of the special game positions 30a, 30b to cause the respin of the remaining reels 12.

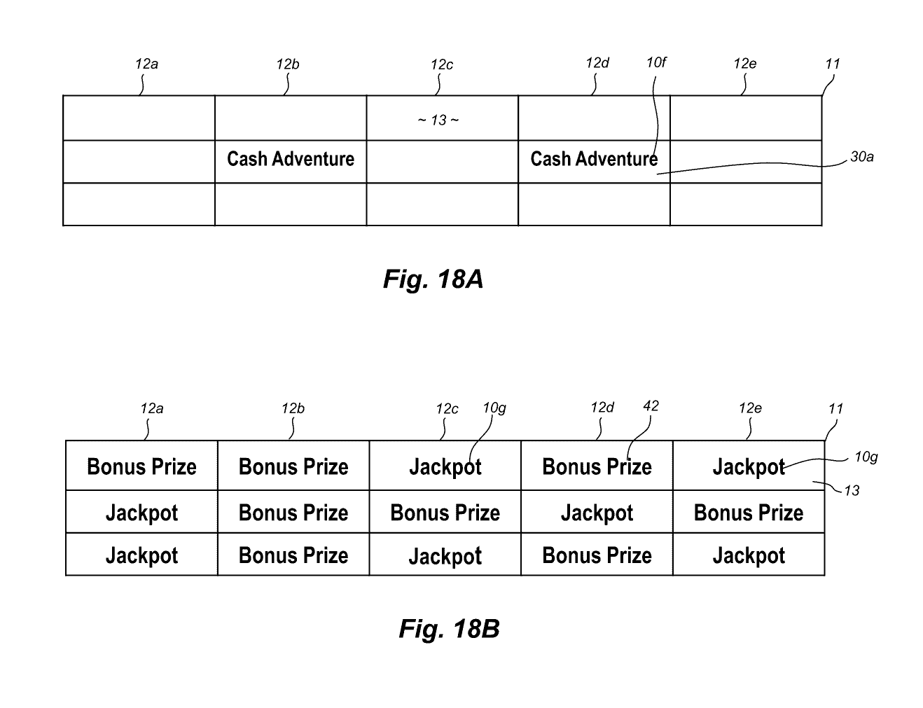

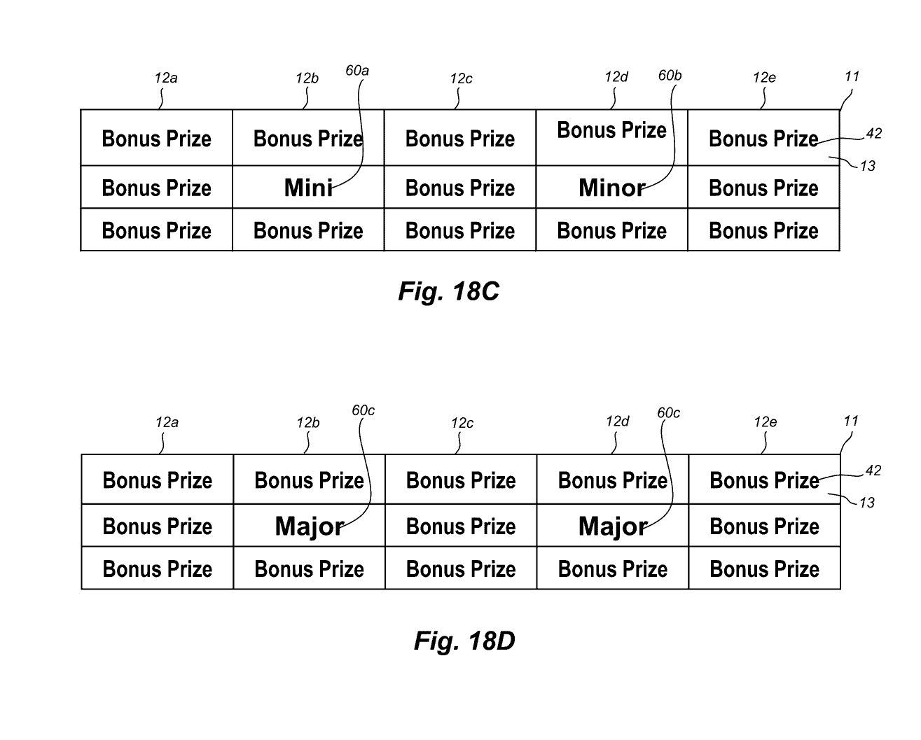

Yet another embodiment employs a different mechanism for awarding the jackpots in the base game 8 and/or feature game 9. Referring to FIGS. 18A and 18B, the appearance of a Cash Adventure symbol 10f in either or both of the red special game positions 30a (as best shown in FIG. 18A) causes the appearance of the Jackpot symbols 10g in one or more of the symbol positions 13 in the array 11 up to the maximum of fifteen symbol positions (as best shown in FIG. 18B). Any remaining symbol positions will award the prizes 42 based on the game symbol 10 shown in each symbol position. The number of displayed Jackpot symbols 10g are then added up and a jackpot is awarded based on the number of Jackpot symbols as indicated, by way of example only, in the table below:

TABLE 1

| Number of Jackpot | Jackpot |
|---|---|
| Symbols 10 g | Level Won |
| 0 to 3 | Mini |
| 4 to 6 | Minor |
| 7 to 9 | Maxi |
| 10 to 12 | Major |
| 12 to 15 | Grand |

Based on the above table, the seven Jackpot symbols 10g appearing in FIG. 18B results in the award of a maxi jackpot to the player in addition to the prizes 42 for the other game symbols 10 in the other symbol positions 13. It will be appreciated that the number of jackpots can vary as can the requisite number of Jackpot symbols 10g that must appear to trigger the award of a jackpot.

In a variation of this jackpot awarding mechanism, the appearance of a Cash Adventure symbol 10f in either or both of the red special game positions 30a (as best shown in FIG. 18A) causes the appearance of a specific jackpot symbol 60 in the red special game positions 30a (as best shown in FIG. 18C). In this case, the jackpot symbols 60 indicate the type of jackpot or jackpot level won by the player. In FIG. 18C, a Mini jackpot symbol 60a and a Minor jackpot symbol 60b are displayed in the red special game positions 30a. On that basis, the highest of the two jackpot symbols is awarded, which would be a minor jackpot. Alternatively, the same jackpot symbol 60 must be shown in both the red special game positions 30a for the jackpot to be awarded. This alternative is shown in FIG. 18D, where two Major jackpot symbols 60c have appeared in the red special game positions 30a after two Cash Adventure symbols 10f appeared in the red special game positions 30a as shown in FIG. 18A. Consequently, the player is awarded the major jackpot and the prizes 42 based on the game symbol 10 shown in each symbol position 13.

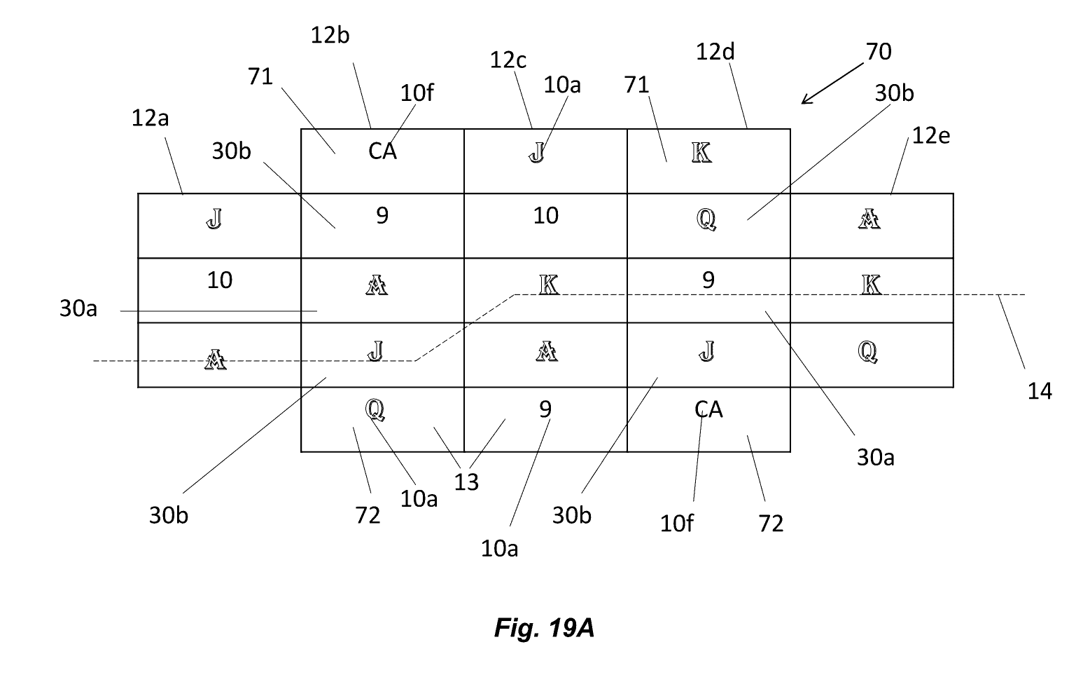

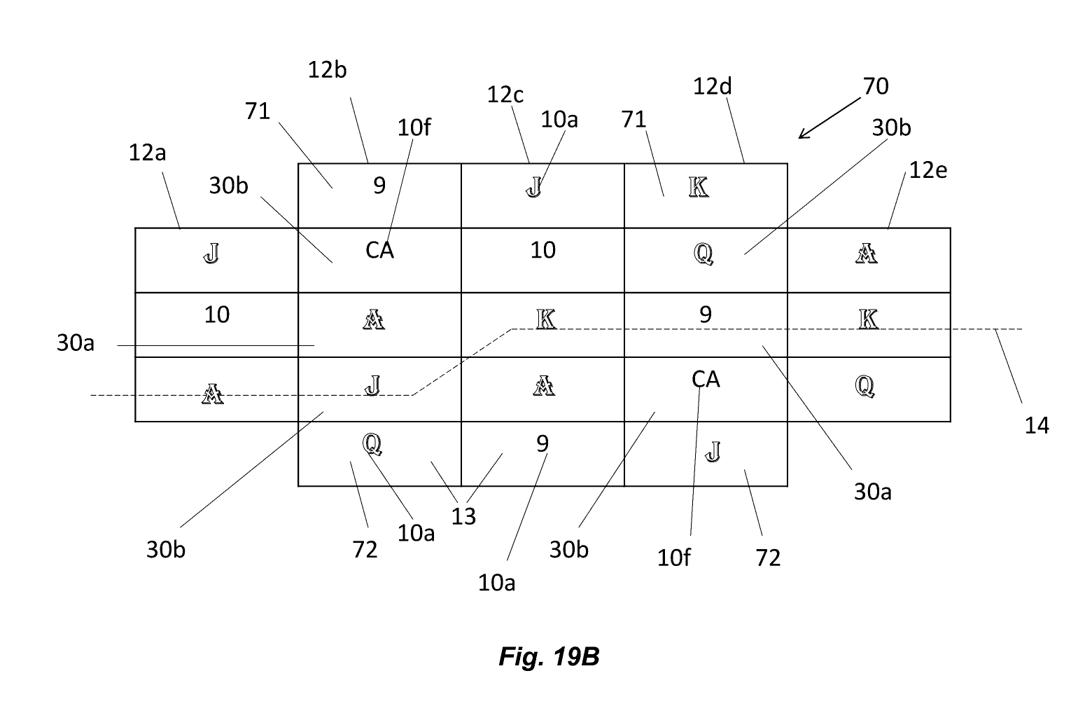

A further embodiment of the invention is illustrated in FIGS. 19A and 19B, where the base game 8 has an array 70 comprising an unequal number of rows for the reels 12a to 12e, with reels 12a, 12e each having a standard three symbol positions 13 to form three rows while reels 12b to 12d each having five symbol positions to form five rows. Pay lines 14 can be formed across any combination of symbol positions 13 from each of the reels 12a to 12e. In this embodiment, the appearance of a Cash Adventure symbol 10f in a symbol position 71, 72 in either the top or bottom of reels 12b, 12d adjacent to one of the blue special game positions 30b causes the electronic game controller 4 to “nudge” the Cash Adventure symbol 10f so that it moves one symbol position either down or up into the blue special game position 30b adjacent that symbol position 71, 72. For example, as best shown in FIG. 19A, the appearance of the Cash Adventure symbol 10f in symbol position 71 of the reel 12b results in it being “nudged” or moved into the adjacent blue special game position 30b of reel 12b, as best shown in FIG. 19B. Likewise, the appearance of the Cash Adventure symbol 10f in symbol position 72 of reel 12d, as best shown in FIG. 19A, causes the Cash Adventure symbol 10f to be “nudged” or moved into the adjacent blue special game position 30b of reel 12b, as best shown in FIG. 19B. This nudging of the Cash Adventure symbol 10f from adjacent symbol positions 71, 72 into the blue special game positions 30a, 30b thus increases the chances of the bonus prizes 42 being awarded to the player.

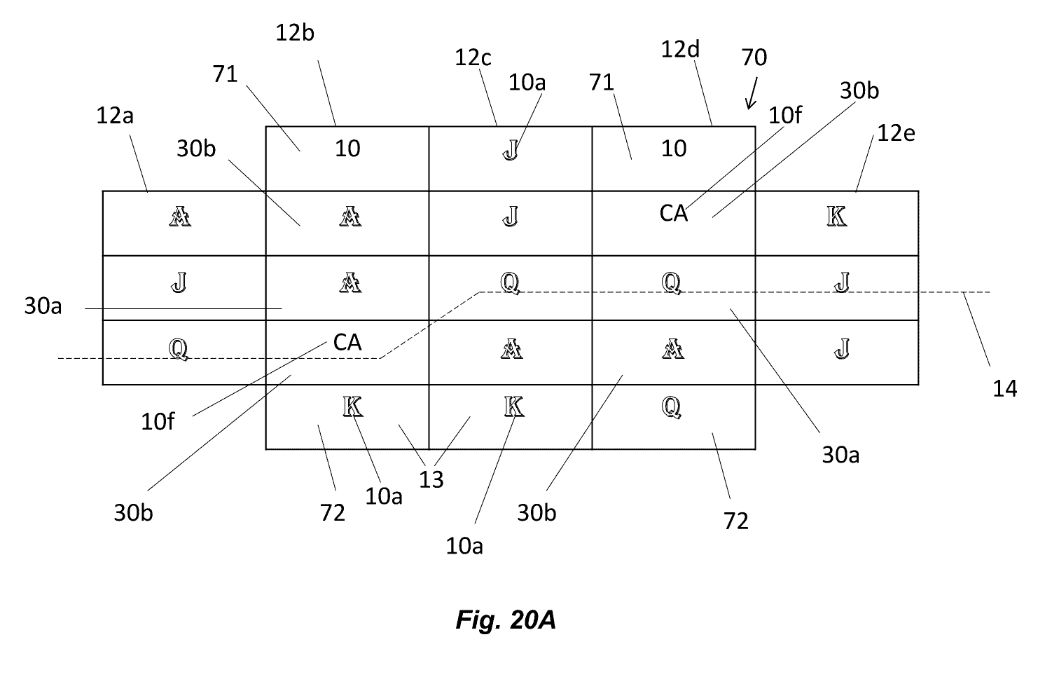

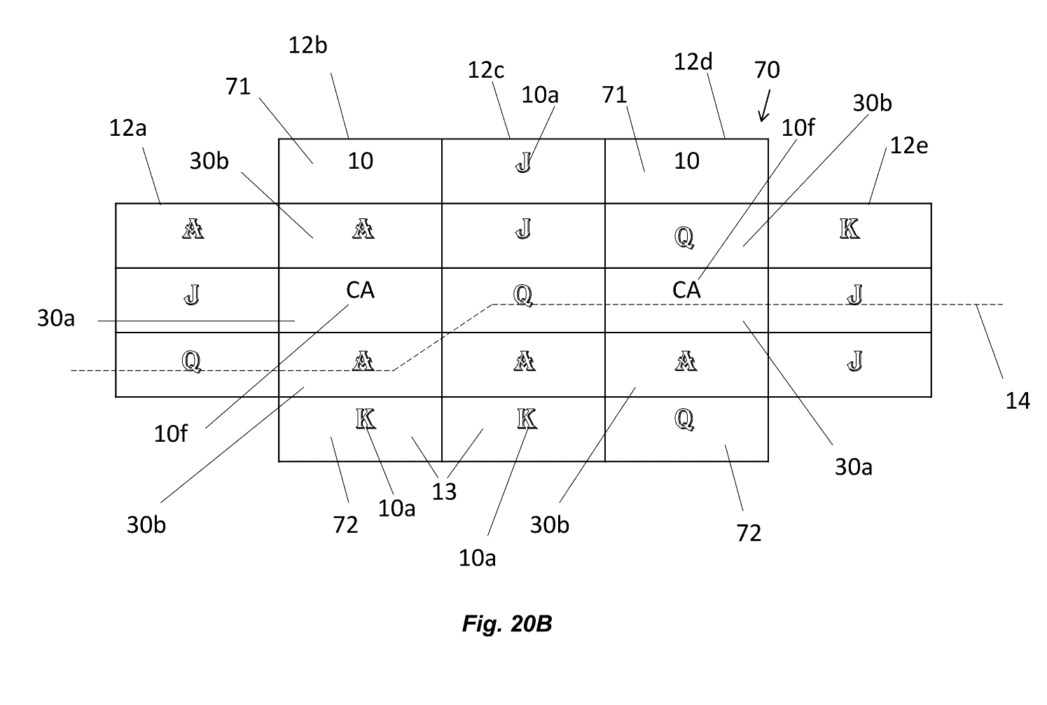

In another embodiment illustrated in FIGS. 20A and 20B, this movement or nudging of the Cash Adventure symbol 10f is alternatively or additionally provided where a Cash Adventure symbol 10f appears in one of the blue special game positions 30b of the reels 12b, 12d adjacent to the red special game position 30a. As best shown in FIG. 20A, the Cash Adventure symbol 10f appearing in the lower blue special game position 30b on reel 12b causes the electronic game controller 4 to “nudge” the Cash Adventure symbol 10f so that it moves one symbol position up into the adjacent red special game position 30a of reel 12b, as best shown in FIG. 20B. Likewise, in FIG. 20A the Cash Adventure symbol 10f appearing in the upper blue special game position 30b on reel 12d causes the electronic game controller 4 to “nudge” the Cash Adventure symbol 10f so that it moves one symbol position down into the adjacent red special game position 30a of reel 12d, as best shown in FIG. 20B. Again, this nudging of the Cash Adventure symbol 10f from adjacent blue special game positions 30b into the red special game positions 30a thus increases the chances of the bonus prizes 42 being awarded to the player.

While FIGS. 19A,19B, 20A and 20B illustrate two instances of nudging at the same time in the same spin or play, it will be appreciated that nudging can occur where only one Cash Adventure symbol 10f appears in an adjacent symbol position 71, 72 or blue special game position 30b. Also, while the embodiments in FIGS. 19A to 20B have been described using an array 70 with unequal rows, it will also be appreciated that nudging of the special game symbol (either the Cash Adventure symbol 10f or the Jackpot symbol 10g) can occur in a regular array having equal numbers of rows and columns, such as a 5×3 or 5×9 array.

In the illustrated embodiments, the game symbol 10a that was in the red or blue special game position 30a, 30b essentially swaps places with the Cash Adventure symbol 10f and appears in the vacated adjacent position 71, 72 or blue special game position 30b. However, in other embodiments, the symbol position 71, 72 or blue special game position 30b displays a randomly selected game symbol 10 or other game symbol like one of the other substitute symbols 10d, 10e, scatter symbol 10c, jackpot symbol 10g or a trigger symbol. In some embodiments, the entire reel 12b, 12d with the adjacent position 71, 72 or blue special game position 30b is nudged so that it turns, shifts, rotates or otherwise moves one position either down or up so that the Cash Adventure symbol 10f moves from the symbol position 71, 72 into the blue special game position 30b adjacent that symbol position 71, 72 or from the blue special game position 30b to the red special game position 30a.

In other embodiments, the base game 8 and the feature game 9 need not be displayed on a single video screen 7. Instead, they may be displayed on separate video screens, with the lower display area 7a appearing in a lower video screen and the upper display area 7b on an upper video screen. Also, the order can be reversed, with the base game 8 and/or feature game 9 appearing on an upper video screen or upper display area 7b of a single video display screen 7 and the information usually shown on the upper display area 7b appearing on a lower video screen or lower display area 7a of a single video display screen.

In another embodiment, the video screen 7 is a touch screen for use in addition to the player-actuatable buttons 6 so as to enable the player to select the bet level (such as bet denominations or bet per pay line 14) as well as other various features, such as making monetary bets for the game, initiating play of any base and feature games played and responding to any messages or requests issued on the electronic gaming machine 1 by the electronic game controller 4. In this case, the player may control when the reels 12 start spinning and stop spinning, either individually or collectively, by simply touching the reels 12. Control over spinning of the reels 12 can also be implemented through the buttons 6 on the console 3. This increases player interaction and provide the player with an opportunity to guess when a particular game symbol 10, such as the Cash Adventure symbol 10f or Jackpot symbol 10g, may appear in the reels 12, such as one of the special game positions 30a, 30b.

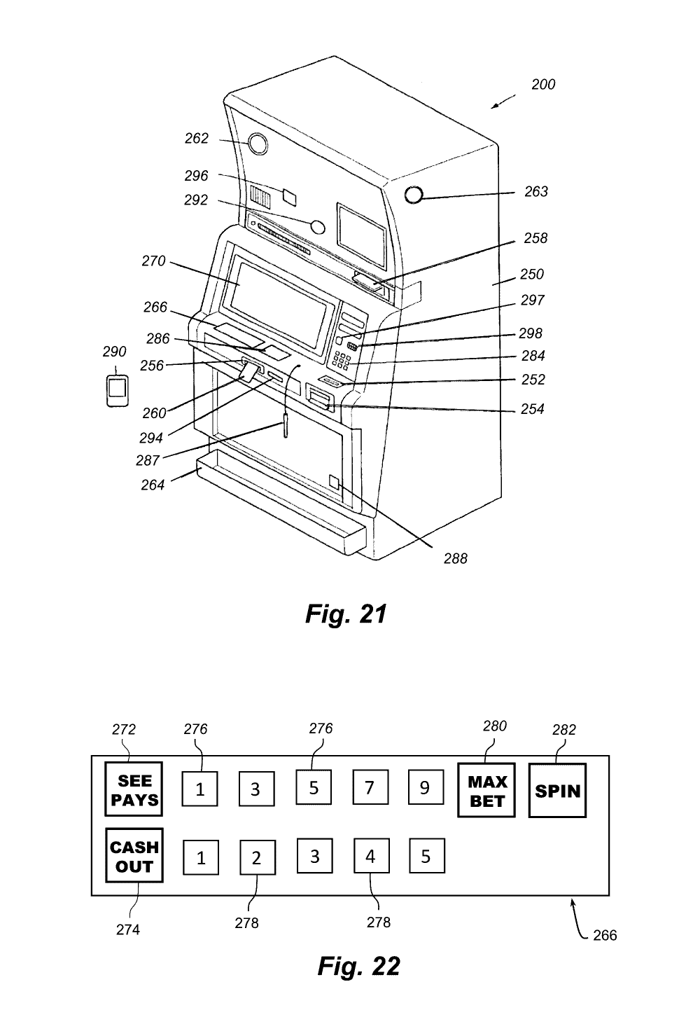

Referring to FIG. 21, another embodiment of the invention is shown in the form of an electronic gaming machine 200. The electronic gaming machine 200 may include a housing or cabinet 250 and one or more value transfer mechanisms or devices, which may include a coin slot or acceptor 252, a paper currency or bill acceptor 254, a ticket reader/printer 256 and a card reader 258, which may be used to input value to the electronic gaming machine 200. A value transfer device may include any device that can accept value from a player. The topper (not shown) may be mounted to the top of the electronic gaming machine 200.

If provided on the electronic gaming machine 200, the ticket reader/printer 256 may be used to read and/or print or otherwise encode ticket vouchers 260. The ticket vouchers 260 may be composed of paper or another printable or encodable material and may have one or more of the following informational items printed or encoded thereon: the casino name, the type of ticket voucher, a validation number, a bar code with control and/or security data, the date and time of issuance of the ticket voucher, redemption instructions and restrictions, a description of an award, and any other information that may be necessary or desirable. Different types of ticket vouchers 260 could be used, such as bonus ticket vouchers, cash-redemption ticket vouchers, casino chip ticket vouchers, extra game play ticket vouchers, merchandise ticket vouchers, restaurant ticket vouchers, show ticket vouchers, etc. The ticket vouchers 260 could be printed with an optically readable material such as ink, or data on the ticket vouchers 260 could be magnetically encoded. The ticket reader/printer 256 may be provided with the ability to both read and print ticket vouchers 260, or it may be provided with the ability to only read or only print or encode ticket vouchers 260. In the latter case, for example, some of the electronic gaming machines 200 may have ticket printers 256 that may be used to print ticket vouchers 260, which could then be used by a player in other electronic gaming machines 200 that have ticket readers 256.

If provided, the card reader 258 may include any type of card reading device, such as a magnetic card reader or an optical card reader, and may be used to read data from a card offered by a player, such as a credit card or a player tracking card. If provided for player tracking purposes, the card reader 258 may be used to read data from, and/or write data to, player tracking cards that are capable of storing data representing the identity of a player, the identity of a casino, the players gaming habits, etc.

The electronic gaming machine 200 may include one or more audio speakers 262, a coin payout tray 264, an input control panel 266, and a colour video display unit 270 for displaying images relating to the game or games provided by the electronic gaming machine 200. The audio speakers 262 may generate audio representing sounds such as the noise of spinning reels, a dealer's voice, music, announcements or any other audio related to a game. The input control panel 266 may be provided with a plurality of pushbuttons or touch-sensitive areas that may be pressed by a player to select games, make wagers, make gaming decisions, etc.

FIG. 20 illustrates one possible embodiment of the control panel 266, which may be used where the electronic gaming machine 200 having a plurality of reels. The control panel 266 may include a “See Pays” button 272 that, when activated, causes the display unit 270 to generate one or more display screens showing the odds or payout information for the game or games provided by the electronic gaming machine 200. As used herein, the term “button” is intended to encompass any device that allows a player to make an input, such as an input device that must be depressed to make an input selection or a display area that a player may simply touch. The control panel 266 may include a “Cash Out” button 274 that may be activated when a player decides to terminate play on the electronic gaming machine 200, in which case the electronic gaming machine 200 may return value to the player, such as by returning a number of coins to the player via the payout tray 264.

The control panel 266 may be provided with a plurality of selection buttons 276, each of which allows the player to select a different number of pay lines prior to spinning the reels. For example, five buttons 276 may be provided, each of which may allow a player to select one, three, five, seven or nine pay lines.

The control panel 266 may also be provided with a plurality of selection buttons 78 each of which allows a player to specify a wager amount for each pay line selected. For example, the electronic gaming machine 200 may be provided with five selection buttons 78, each of which may allow a player to select 1¢, 2¢, 5¢, 10¢ and 20¢, to wager for each pay line selected. In that case, if a player were to activate one of the buttons 276 to select five pay lines and then activate one of the buttons 278 to select 5¢ per pay line to be wagered or bet, the total wager would be $0.25.

The control panel 266 may include a “Max Bet” button 280 to allow a player to make the maximum wager allowable for a game. In the above example, where up to nine pay lines were provided and up to 20¢ could be wagered for each pay line selected, the maximum wager would be $1.80 The control panel 266 may include a spin button 282 to allow the player to initiate spinning of the reels after a bet has been made.

In FIG. 22, a rectangle is shown around the buttons 272, 274, 276, 278, 280, 282. It should be understood that the rectangle simply designates, for ease of reference, an area in which the buttons 272, 274, 276, 278, 280, 282 may be located. Consequently, the term “control panel” should not be construed to imply that a panel or plate separate from the housing 250 of the electronic gaming machine 200 is required, and the term “control panel” may encompass a plurality or grouping of player activatable buttons.

Although one possible control panel 266 is described above, it should be understood that different buttons could be utilized in the control panel 266, and that the particular buttons used may depend on the game or games that could be played on the electronic gaming machine 200. Although the control panel 266 is shown to be separate from the display unit 270, it should be understood that the control panel 266 could be generated by the display unit 270. In that case, each of the buttons of the control panel 266 could be a coloured area generated by the display unit 270, and some type of mechanism may be associated with the display unit 270 to detect when each of the buttons was touched, such as a touch-sensitive screen.

As noted above, the electronic gaming machine 200 may include a mechanism by which the electronic gaming machine 200 may determine the identity of the player. In particular, the card reader 258 may be used to read a card that carries an identification code that may be uniquely associated with the player so that the gaming unit can differentiate that player from all other players, or so that the gaming unit can differentiate that player as a member of a group of players from all player not a member of the group of players. The electronic gaming machine 200 may also include equipment, such as a keypad 284, an input pad 286 (with optional stylus 287), a port (or antenna) 288 adapted to communicate via a wired or wireless link (infrared or radio frequency link, for example) to a mobile electronic device 290 (such as a personal digital assistant, smart phone or tablet), a camera 292, a scanner 294, a retinal (or iris) scanner 296, fingerprint scanner 297, and/or a microphone 298. The electronic gaming machine 200 may include any one of the devices 258, 284, 286, 288, 290, 292, 294, 296, 297, 298, or the electronic gaming machine 200 may include a combination of some or all of the devices 258, 284, 286, 287, 288, 290, 292, 294, 296, 297, 298.

In operation, a player may identify him or herself to the electronic gaming machine 200 by entering a unique numeric or alpha-numeric code using the key pad 284, for example. Alternatively, the player may use his or her finger or the stylus 287 to sign his or her signature on the input pad 286. As a further alternative, the player may sign his or her signature on the mobile electronic device 290, which signature is then converted to electronic data, and the data is then transferred via the port/antenna 288 to the electronic gaming machine 200. As yet another alternative, the player may sign his or her signature on a piece of paper that is then photographed using the camera 292 or scanned using the scanner 294 (or the bill acceptor 254) to convert the signature into electronic data. As an additional alternative, the player may place one of his or her fingers or his or her hand on the scanner 297 and the scanner 297 may generate an electronic data representation of the fingerprint on one or more of the player's fingers or an electronic data representation of the pattern of the entire hand. Alternatively, the camera 292 may be used to take a picture (live or still) of the player, the picture then being converted into electronic data. As a still further alternative, the player may place his or her eye up to the retinal (or iris) scanner 296, and the retinal (or iris) scanner 296 may generate an electronic data representation corresponding to the pattern of the retina (or iris) of the player. As yet another alternative, the player may speak into the microphone 298, and characteristics of the spoken words (or voiceprint) may be converted into an electronic data representation.

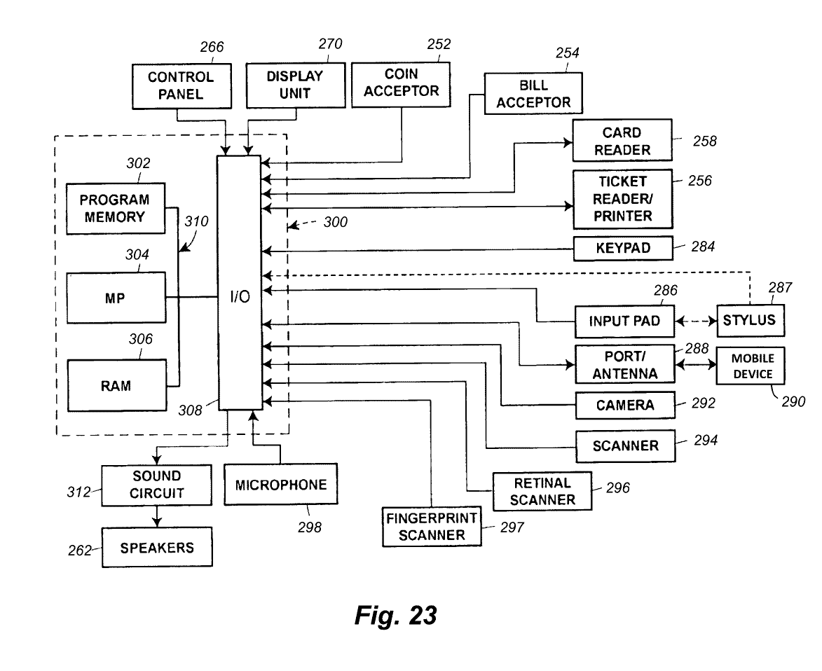

FIG. 23 is a block diagram of a number of components that may be incorporated in the electronic gaming machine 200. Referring to FIG. 23, the electronic gaming machine 200 may include a controller 300 that may comprise a program memory 302, a microcontroller or microprocessor (MP) 304, a random-access memory (RAM) 306 and an input/output (I/O) circuit 308, all of which may be interconnected via an address/data bus 310. It should be appreciated that although only one microprocessor 304 is shown, the controller 300 may include multiple microprocessors 304. Similarly, the memory of the controller 300 may include multiple RAMs 306 and multiple program memories 302. Although the I/O circuit 108 is shown as a single block, it should be appreciated that the I/O circuit 308 may include a number of different types of I/O circuits. The RAM(s) 304 and program memories 302 may be implemented as semiconductor memories, magnetically readable memories, and/or optically readable memories, for example.

FIG. 23 illustrates that the coin acceptor 252, the bill acceptor 254, the ticket reader/printer 256, the card reader 258, the control panel 266, the display unit 270, the keypad 284, the input pad 286 (and optionally the stylus 287), the port/antenna 288, the digital camera 292, the scanner 294, the retinal scanner 296, the fingerprint scanner 297 and the microphone 298 may be operatively coupled to the I/O circuit 308, each of those components being so coupled by either a unidirectional or bidirectional, single-line or multiple-line data link, which may depend on the design of the component that is used. The speaker(s) 262 may be operatively coupled to a sound circuit 312, that may comprise a voice- and sound-synthesis circuit or that may comprise a driver circuit. The sound-generating circuit 312 may be coupled to the I/O circuit 308.

As shown in FIG. 23, the components 252, 254, 256, 258, 266, 270, 284, 286, 287, 288, 292, 294, 296, 297, 298, 312 may be connected to the I/O circuit 308 via a respective direct line or conductor. Different connection schemes could be used. For example, one or more of the components shown in FIG. 12 may be connected to the I/O circuit 308 via a common bus or other data link that is shared by a number of components. Furthermore, some of the components may be directly connected to the microprocessor 304 without passing through the I/O circuit 308.

It will be appreciated that while the preferred embodiments have been described in relation to an industry standard electronic gaming machine, the invention can be readily applied to other types of electronic gaming machines, including a personal computer (standing alone or connected to a communications network, LAN or WAN), mobile electronic devices (such as handheld or portable electronic devices like tablets and smart phones) and other electronic devices capable of displaying a game. In the case of mobile electronic device, in one arrangement it may permit the player to make bets using “virtual” credits that represent a monetary value, but do not require the player to make a monetary transaction. Instead, the invention may provide a tiered access to the various features of the game so that the player can make relatively small payments to access particular features of the game or obtain additional benefits during game play. An alternative arrangement would require the player to purchase virtual credits or tokens via an interface on the mobile electronic device or an online interface accessible by the mobile electronic device. Similarly, either of the above described arrangements can be applied where the invention is implemented on a personal computer (PC) connected to the internet (wirelessly or not). In one example of the implementation, the PC would access an online casino over the internet to play the game of the invention or the game of the invention would be part of a social networking website. It is also contemplated that the player could also make regular payments to subscribe to continue playing the game on the mobile electronic device, PC or other electronic device.

In an alternative embodiment, the electronic gaming machine also provides an option for the player to play with either credits based on a monetary amount or virtual credits as discussed above. This can be implemented by way of a selection menu prior to playing the selected game or by providing a suitable menu button on screen during play of the selected game.

In another aspect, the invention includes a computer program configured to perform the invention. In this way the invention can be implemented in various ways on an electronic gaming machine. In a further aspect, the invention includes a gaming system configured comprising a central processing unit (such as a computer or computational processor) configured for communication with an electronic gaming machine to perform the invention. In a yet another aspect, the invention includes a non-transitory computer readable or carrier medium carrying computer executable code that, when executed on a central processing unit configured for communication with an electronic gaming machine, causes said central processing unit to perform the invention. In this case, the non-transitory carrier medium includes an external hard drive, a memory device, including a memory card, smart card, a radio frequency identification (RFID) device, USB key, magnetic card or other electronic storage device.

It will further be appreciated that any of the features in the preferred embodiments of the invention can be combined together and are not necessarily applied in isolation from each other. For example, the feature of the player being able to selectively starting or stopping spinning of the reels 12 and the feature of providing separate video screens for the lower display area 7a and upper display area 7b can be combined into a single electronic gaming machine 1. Similar combinations of two or more features from the above described embodiments or embodiments of the invention can be readily made by one skilled in the art.

By providing a special game position that can award prizes for game symbols displayed in game positions associated with the special game position, the player's interest in the electronic gaming machine is increased as there is a higher chance of winning additional prizes and thus increasing the value won by the player in a play of the game. Thus, the invention retains the player interest and so the player is likely to continue playing the same electronic gaming machine. The player's anticipation and excitement is also heightened as he or she knows that a prize will be awarded upon the appearance of a special symbol in the special game position, and the value of the prize depends on the game symbol displayed in the associated game position. Hence, the player will pay more attention to the visually indicated special game position in the (base and/or feature) game and then to the associated game positions. The invention also adds greater value to a player in terms of the probability of winning a prize (including jackpot prizes) and providing greater variety in game play, especially compared to a conventional electronic gaming machine that only has one set of reels and a single feature game. This value to the player is increased in the preferred embodiments of the invention by extending play of the special game position to the feature game in addition to the base game. All these advantages of the invention result in the player being more likely to retain interest in continuing to play the same electronic gaming machine due to the variation in game play on the electronic gaming machine. Furthermore, since the electronic game controller controls operation of the electronic gaming machine, the invention can be readily implemented to existing gaming machines and other gaming systems. In all these respects, the invention represents a practical and commercially significant improvement over the prior art.

Although the invention has been described with reference to specific examples, it will be appreciated by those skilled in the art that the invention may be embodied in many other forms.

1. An electronic gaming machine comprising:
a display for displaying a game, wherein said game comprises game symbols arranged into an array of predetermined game positions and where predetermined winning combinations of randomly selected game symbols in said game award prizes to a player;
an electronic game controller for controlling the display of said game symbols on said display; and
a value transfer mechanism for receiving value from a player to make a bet and initiate play of said game on said display, said value transfer mechanism being in electronic communication with said electronic game controller;
wherein said electronic game controller in response to said player making a bet via said value transfer mechanism commences play of said game by randomly selecting game symbols and transmitting a signal to said display to display said randomly selected game symbols;
wherein said electronic game controller designates at least one of said predetermined game positions as a special game position in said array, said game symbols being displayable in said special game position;
wherein two or more game positions are associated with said special game position; and
wherein a special symbol appearing in said special game position in a play of said game causes said electronic game controller to award a prize for each associated game position, said prizes being based on the game symbols displayed in said associated game positions.

2. The electronic gaming machine of claim 1, wherein a first game symbol is associated with a higher value than a second game symbol and the prize awarded for said first game symbol displayed in one of said associated game positions is higher in value than the prize awarded for said second game symbol displayed in one of said associated game positions.

3. The electronic gaming machine of claim 1, wherein said game symbols have different values and each said prize is based on the value of the game symbol displayed in each said associated game position.

4. The electronic gaming machine of claim 3, wherein said game symbols have different values and each said prize increases in value as the value of the game symbol displayed in each said associated game position increases.

5. The electronic gaming machine of claim 1, wherein each said prize is proportional to the value of the game symbol displayed in each said associated game position.

6. The electronic gaming machine of claim 1, wherein said prize comprises a monetary prize or an amount of credits.

7. The electronic gaming machine of claim 1, wherein each said prize is displayed in each said associated game position.

8. The electronic gaming machine of claim 7, wherein each said prize is superimposed over the game symbol displayed in each associated game position.

9. The electronic gaming machine of claim 1, wherein said associated game positions comprise the game positions adjacent said special game position.

10. The electronic gaming machine of claim 1, wherein said associated game positions comprise the game positions surrounding said special game position.

11. The electronic gaming machine of claim 1, wherein said special game position is visually indicated on said array to said player during each play of said game by a graphical element associated with said special game position.

12. The electronic gaming machine of claim 11, wherein said graphical element comprises at least one of a highlighted boundary of said special game position and an animation associated with said special game position.

13. The electronic gaming machine of claim 1, wherein said array comprises rows and columns of predetermined game positions and said associated game positions comprise the predetermined game positions in the same column as said special game position.

14. The electronic gaming machine of claim 13, wherein said associated game positions comprise the predetermined game positions in at least one column adjacent to the column containing said special game position.

15. The electronic gaming machine of claim 13, wherein said associated game positions comprise the predetermined game positions in the adjacent columns on either side of the column containing said special game position.

16. The electronic gaming machine of claim 1, wherein said array comprises rows and columns of predetermined game positions and said associated game positions comprise the predetermined game positions in at least one column adjacent to the column containing said special game position.

17. The electronic gaming machine of claim 1, wherein there are two or more special game positions on said array, each special game position having respective associated game positions.

18. The electronic gaming machine of claim 1, wherein the appearance of said special symbol in a symbol position adjacent to said special game position causes said special symbol to move into said special game position.

19. The electronic gaming machine of claim 18, wherein said special symbol swaps places with the game symbol in said special game position.

20. The electronic gaming machine of claim 1, wherein said special symbol comprises a jackpot symbol and the appearance of said jackpot symbol in said special game position causes the award of a jackpot prize.

21. The electronic gaming machine of claim 20, wherein there is a plurality of special game positions and the number of said jackpot symbols in said special game positions increases the value of said jackpot prize.

22. The electronic gaming machine of claim 1, wherein the frequency of said special symbol appearing in said array depends on the amount bet by said player to play said game.

23. The electronic gaming machine of claim 22, wherein said frequency of said special symbol appearing in said array increases as said amount bet increases.

24. The electronic gaming machine of claim 22, wherein said amount bet comprises the total amount bet for a play of said game.
